(19) United States
(12) Patent Application Publication
(10) Pub. No.: US 2016/0142746 A1
(43) Pub. Date: May 19, 2016

(54) METHOD OF ENCRYPTING, STREAMING, AND DISPLAYING VIDEO CONTENT USING SELECTIVE ENCRYPTION

(71) Applicant: Thales Avionics, Inc., Irvine, CA (US)

(72) Inventor: Pierre A. Schuberth, Corona del Mar, CA (US)

(21) Appl. No.: 14/541,475

(22) Filed: Nov. 14, 2014

(51) Int. Cl. H04N 21/2387; H04N 21/214; H04N 21/4405; H04N 21/2365; H04N 21/236; H04N 21/414; H04L 29/06; H04N 21/2347

(52) U.S. Cl. CPC H04N 21/2387; H04L 63/0457; H04N 21/2146; H04N 21/2347; H04N 21/2365; H04N 21/236; H04N 21/41422; H04N 21/4405; H04N 21/23605

(57) ABSTRACT

Video may be provided at a display unit using an encrypted transport stream of a content file. During normal play operation, a plurality of transport stream packets of the encrypted transport stream may be received, where a packetized elementary stream of video frame packets including independently coded and dependently coded video frame packets is multiplexed onto the encrypted transport stream. Payloads of transport stream packets including data of independently coded video frame packets may be selectively decrypted without decrypting payloads of transport stream packets not including data of independently coded video frame packets. The independently and dependently coded video frame packets from the payloads of the transport stream packets may be decoded using the selectively decrypted payloads of the transport stream packets, and the decoded video frame packets of the independently and dependently coded video frame packets may be provided for display.

### BACKGROUND

The present disclosure relates to processing of video data, and more particularly, to processing of encrypted video data and related systems/devices.

In-flight entertainment systems (IFES) have been deployed onboard aircraft to provide entertainment for passengers in a passenger cabin. In-flight entertainment systems typically provide passengers with video and audio programming. Some in-flight entertainment systems include an electronic communications network having a head-end server and seat-end electronics boxes that are coupled with video display units (also referred to as seat video display units or SVDUs) located at passenger seats. The video display units display content that is distributed to the seat-end electronics boxes from the head-end server over the communications network.

A user's control of content displayed on a video display unit may be facilitated via a user interface configured to accept user input. User interfaces to existing IFE systems may include a touch screen on a dedicated seat display monitor or video display unit disposed at the passenger seat, such as in the seat back in front of the passenger seat. User interfaces may also include a fixed or tethered remote control unit at a passenger seat that is within reach of the passenger. Remote control units may include fixed mechanical buttons and/or a touch sensitive interface/screen. User control may include content selection, play, stop, volume control, brightness control, and/or trick mode commands (e.g., fast forward, fast rewind, and/or random access).

Copyrighted content encryption/decryption methods may be applied to In-Flight Entertainment Systems (IFES), Audio and Video On Demand (AVOD) systems (e.g., streaming servers and clients), and/or MPEG (Moving Picture Experts Group) players of local content (e.g., seat centric processing by seat video display units).

IFES onboard aircraft may store a combination of audio and video content from old classics to early release window (ERW) for passenger consumption during flights. ERW is a time after theatrical release but before DVDs/BDs (Digital Versatile Discs/Blu-ray Discs) are made available for sale to the public. The value of this content may be especially high because DVDs/BDs have not yet been released, and because Airline content may contain multiple languages, multiple Closed Captions (CC), and multiple subtitles (SUBs). Airlines are required by Content Owners to protect against content piracy.

Content security is governed by MPAA (Motion Picture Association of America) security rules. A description to handle Early Window Content in Standard Definition (SD) or NTSC (National Television System Committee) is included in WAEA (World Airline Entertainment Association, now APEX, Airline Passenger Experience Association) Specification 0598 “DVD Delivery for In-Flight Entertainment” version 1.0, adopted on Jan. 24, 2001, by the APEX Technology Committee, the disclosure of which is hereby incorporated herein in its entirety by reference.

Rules from Section 11.4 of WAEA Specification 0598, “Secure Environment and Facilities,” are provided as follows. A Secure Environment is defined as an environment where access to Early Window Content and encryption/decryption keys are closely controlled in Secure Facilities as defined by MPAA and therefore content and keys can be in plaintext (i.e., without encryption). Secure Facilities have the following highly desirable characteristics:
1. A clear, structurally-delineated restricted perimeter,
2. Physical access to secured areas is monitored and limited to authorized personnel,
3. Security processes and procedures are codified and enforced, and
4. Inventory and movement of individual Early Window Content and keys is tracked and traceable.
   As defined, secure Facilities have all the above characteristics and include at least one of the following additional characteristics:
1. Facilities that have adopted the recommendations resulting from an MPAA security review,
2. Facilities that are JAR (Joint Aviation Regulation) 145 and/or FAR (Federal Aviation Regulation) 145 approved (Repair Stations),
3. Facilities that are JAR 21 and/or FAR 21 approved (Certification Procedures for Products and Parts),
4. Those portions of airport premises which are within the airport security perimeter (commonly referred to as “airside”), and
5. IFES equipment installed on a commercial passenger aircraft.

Transport of Early Release Window (ERW) Content with Decryption Keys between noncontiguous Secure Environments shall be traceable pursuant to JAR 145 and/or FAR 145. It is highly desirable that the Decryption Key be rendered unusable during transport between noncontiguous Secure Environments. Transport of Copyrighted Content and Decryption Keys shall occur only in encrypted form. This means that Decryption Keys shall not exist in clear form except within the boundaries of a Security Module.

Common encryption technologies are based on “file encryption” where the whole MPEG-2 TS (MPEG-2 Transport Stream) file (content title.mpg) is encrypted (including headers & payloads). This technology is applied to content in transit only and content could exist in clear form within the boundaries of a Secure Facility.

Note that an MPEG-2 TS specifies a container format encapsulating packetized elementary streams (PESs). An MPEG-2 TS contains many types of PESs identified by their respective unique PIDs (Packet Identifiers):
1. Video packets for the visual part of one content, including:
   1.1. I-frames: Intra-coded pictures as they can be decoded independently of any other frames,
   1.2. P-frames: Predicted pictures which contain only changes with respect to a previous frame,
   1.3. B-frames: Bi-predictive pictures which contain only changes with respect to previous and following frames,
2. Audio packets for the multiple languages provided to passengers,
3. Closed Caption packets for hard of hearing passengers, and
4. Subtitles for foreign passengers.

The passenger, after selecting a movie, may need to select an audio language track and may select a closed caption and/or a subtitle language too. Content that is “file-encrypted” may present the following problems.

For trick mode operations (i.e., Fast Forward, Fast Reverse, and/or Random Access operations), the video server may be deeply involved because it has to extract one I-Frame from every n I-Frames (based on Fast Forward speed or Fast Reverse speed) and stream them to the seat for decoding. When content is “file-encrypted”, the server may be unable to do this task without decrypting each transport stream TS packet because the TS packet headers are encrypted, and the server may be unable to detect any video packetized elementary stream packet headers (and therefore, any I-Frame Packet Identifications or PIDs) from the encrypted file.

Some VOD servers use index files to index the start points of I-frames to provide trick mode operations or to jump to chapters. When content is “file-encrypted”, however, the server may be unable to use index files because the packet headers are encrypted so that detection of start points in the encrypted file may be difficult.

The encryption strength recommended by APEX is to use the Advanced Encryption Standard (AES) with a 128-bit symmetric key with Cypher Block Chaining (CBC). AES is a block encryption process (block size of 128 bits or 16 Bytes) that uses a symmetric key (symmetric because it is the same key for encryption and decryption) and an Initialization Vector IV (16 Bytes). The IV is used in the first block to make each encryption unique. With CBC, each block of plaintext is XORed with the previous ciphertext block before encryption. Therefore, each ciphertext block is dependent on all plaintext blocks processed up to that point. Streaming an encrypted file as described with missing data caused by network errors may cause decryption to be unable to decode and present any further content in the file. Use of CBC may thus require decryption from a complete, error-free file. This may be reasonable and acceptable if the decryption is performed at the airport facility or on the aircraft server. It may not be reasonable, however, to expect every bit of the file to be transferred to the seat video display unit SVDU error free.

With the availability of High Definition (HD) content to Airlines, Hollywood studios are now increasing the content security on IFES by requiring that “HD video content shall be maintained encrypted while on board except during playback”. Therefore, encrypted content should be stored and streamed, and trick mode capabilities should be preserved.

Methods providing data transport stream encryption are discussed, for example, in U.S. Pat. No. 7,991,997 to Watson et al., entitled “System And Method For Providing Searchable Data Transport Stream Encryption,” the disclosure of which is incorporated herein in its entirety by reference. As discussed in this patent, by encrypting only the frame payload, the header remains unencrypted and can be applied to prepare the encrypted frame payload for presentation.

Use of trick mode capabilities (e.g., fast forward, fast rewind, random access, etc.) with an encrypted transport stream may be difficult and/or computationally intensive, however, because all transport stream packet payloads (including packetized elementary stream packet headers and packet data) may be encrypted.

### SUMMARY

According to some embodiments, methods may provide video at a display unit using an encrypted transport stream of a content file. During normal play operation, a plurality of transport stream packets of the encrypted transport stream may be received, where a packetized elementary stream of video frame packets including independently coded video frame packets (e.g., I-frames) and dependently coded video frame packets (e.g., P-frames and/or B-frames) is multiplexed onto the encrypted transport stream. During normal play operation, payloads of transport stream packets including data of independently coded video frame packets may be selectively decrypted without decrypting payloads of transport stream packets not including data of independently coded video frame packets. During normal play operation, the independently and dependently coded video frame packets from the payloads of the transport stream packets may be decoded using the selectively decrypted payloads of the transport stream packets including data of the independently coded video frame packets. During normal play operation, the decoded video frame packets of the independently and dependently coded video frame packets may be provided for display on a display.

During trick mode operation, a plurality of transport stream packets of the content file may be received wherein each of the plurality of transport stream packets includes a respective portion of an independently coded video frame packet of the packetized elementary stream of video frame packets. During trick mode operation, payloads of the plurality of transport stream packets including the respective portions of the independently coded video frame packet may be decrypted, the independently coded video frame packet may be decoded using the decrypted payloads of the plurality of transport stream packets, and the decoded independently coded video frame packet may be decoded for display on the display unit.

The plurality of transport stream packets may include a plurality of sequential transport stream packets including respective portions of the independently coded video frame packet, and a last of the sequential transport stream packets may include a respective portion of the independently coded video frame packet and a portion of a dependently coded video frame packet. During trick mode operation, data of the dependently coded video frame packet from the last of the sequential transport stream packets may be discarded by the SVDU player.

Each of the transport stream packets that does not include data of an independently coded video frame packet may include a first flag value (also referred to as a non-encryption flag) set in a header thereof, a header of an initial one of the sequential transport stream packets including data of the independently coded video frame packet may include a second flag value (also referred to as an encryption flag) set in a header thereof, and the first and second flag values may be different.

Headers of each non-initial one of the sequential transport stream packets including data of the independently coded video frame packet may include the second flag value set in a header thereof. According to other embodiments, headers of each non-initial one of the sequential transport stream packets including data of the independently coded video frame packet may include a third flag value set in a header thereof, with the first, second, and third flag values being different.

Each of the transport stream packets that does not include data of an independently coded video frame packet may include a first flag value set in a header thereof, each of the transport stream packets that includes data of an independently coded video frame packet may include a second flag value and/or a third flag value set in a header thereof, and selectively decrypting may include selectively decrypting responsive to detecting the second and/or third flag value set in the headers of the transport stream packets including data of independently coded video frame packets.

Each of the transport stream packets that does not include data of an independently coded video frame packet may include a first flag value set in a header thereof, each of the transport stream packets that includes data of an independently coded video frame packet may include a second flag value set in a header thereof, and selectively decrypting may include selectively decrypting responsive to detecting the second flag value set in the headers of the transport stream packets including data of independently coded video frame packets.

In addition, a packetized elementary stream of audio packets may be multiplexed with the packetized elementary stream of video frame packets onto the transport stream.

Providing the decoded video frame packets of the independently and dependently coded video frame packets for display may include rendering video images of the decoded video frame packets on the display.

According to some embodiments, a video display may include a network interface configured to provide communications with a server and a processor coupled to the network interface. During normal play operation, the processor may be configured to receive a plurality of transport stream packets of the encrypted transport stream through the network interface, where a packetized elementary stream of video frame packets including independently coded and dependently coded video frame packets is multiplexed onto the encrypted transport stream. During normal play operation, the processor may be configured to selectively decrypt payloads of transport stream packets including data of independently coded video frame packets without decrypting payloads of transport stream packets not including data of independently coded video frame packets. During normal play operation, the processor may be configured to decode the independently and dependently coded video frame packets from the payloads of the transport stream packets using the selectively decrypted payloads of the transport stream packets including data of the independently coded video frame packets. During normal play operation, the processor may be configured to provide the decoded video frame packets of the independently and dependently coded video frame packets for display on a display.

During trick mode operation, the processor may be configured to receive a plurality of transport stream packets of the content file through the network interface wherein each of the plurality of transport stream packets includes a respective portion of an independently coded video frame packet of the packetized elementary stream of video frame packets. During trick mode operation, the processor may be configured to decrypt payloads of the plurality of transport stream packets including the respective portions of the independently coded video frame packet, decode the independently coded video frame packet using the decrypted payloads of the plurality of transport stream packets, and provide the decoded independently coded video frame packet for display.

According to some other embodiments, a method of streaming an encrypted transport stream of a content file may include providing the encrypted transport stream in memory. The encrypted transport stream may include a plurality of transport stream packets, a packetized elementary stream of video frame packets including independently coded and dependently coded video frame packets may be multiplexed onto the transport stream, a first flag value may be set in headers of transport stream packets without data of independently coded video frame packets, and a second flag value may be set in headers of transport stream packets including data of independently coded video frame packets. During normal play operation, transport stream packets having the first flag value and transport stream packets having the second flag value may be streamed so that independently coded and dependently coded video frame packets are streamed. During trick mode operation, transport stream packets having the second flag value may be selectively streamed without streaming transport stream packets having the first flag value.

A packetized elementary stream of audio packets may be multiplexed with the packetized elementary stream of video frame packets onto the transport stream, a packetized elementary stream of closed caption packets may be multiplexed with the packetized elementary stream of video frame packets onto the transport stream, and/or a packetized elementary stream of subtitle packets may be multiplexed with the packetized elementary stream of video frame packets onto the transport stream.

Streaming transport stream packets during normal play operation may include streaming transport stream packets responsive to receiving a play command, and selectively streaming transport stream packets having the second flag value during trick mode operation may include selectively streaming responsive to receiving a fast forward and/or a fast reverse command.

Streaming transport stream packets during normal play operation may include streaming transport stream packets to a display unit, and streaming transport stream packets during trick mode operation may include selectively streaming transport stream packets to the display unit.

According to some other embodiments, a head end server of an entertainment system may include a network interface configured to provide communication with a video display unit, a memory configured to store an encrypted transport stream of a content file, and a processor coupled with the network interface and the memory. More particularly, the encrypted transport stream may include a plurality of transport stream packets, a packetized elementary stream of video frame packets including independently coded and dependently coded video frame packets may be multiplexed onto the transport stream, a first flag value may be set in headers of transport stream packets without data of independently coded video frame packets, and a second flag value may be set in headers of transport stream packets including data of independently coded video frame packets. During normal play operation, the processor may be configured to stream transport stream packets having the first flag value and transport stream packets having the second flag value so that independently coded and dependently coded video frame packets are streamed. During trick mode operation, the processor may be configured to selectively stream transport stream packets having the second flag value without streaming transport stream packets having the first flag value.

According to still other embodiments, a method may be provided to encrypt a transport stream of a content file including a plurality of transport stream packets, wherein a packetized elementary stream of video frame packets including independently coded and dependently coded video frame packets is multiplexed onto the transport stream. The method may include setting a first flag value in a header of a first transport stream packet of the transport stream indicating that the first transport stream packet does not include data of an independently coded video frame packet, and setting a second flag value in a header of a second transport stream packet of the transport stream indicating that the second transport stream packet includes data of an independently coded video frame packet, with the first and second flag values being different. In addition, a payload of the second transport stream packet may be selectively encrypted without encrypting the headers of the first and second transport stream packets and without encrypting the payload of the first transport stream packet.

Setting the header field of the first transport stream packet may include setting the header field of the first transport stream packet to the first flag value without encrypting the payload of the first transport stream packet.

The first transport stream packet may include data of a dependently coded video frame packet, with a dependently coded video frame packet being dependent on information of at least one other video frame packet of the packetized elementary stream of video frame packets for decoding.

The independently coded video frame packet may be coded independently of any other video frame packets of the packetized elementary stream.

The independently coded video frame packets of the packetized elementary stream may include intra-coded video frame packets, and the dependently coded video frame packets of the packetized elementary stream may include inter-coded video frame packets.

The inter-coded video frame packets of the packetized elementary stream may include predicted video frame packets that are dependent on one other video frame packet of the packetized elementary stream of video frame packets for decoding and bi-predicted video frame packets that are dependent on two other video frame packets of the packetized elementary stream of video frame packets for decoding.

The transport stream of the content file may include a transport stream according to an MPEG standard, with the intra-coded video frame packets including I-frame video packets according to the MPEG standard, with the predicted video frame packets including P-frame video packets according to the MPEG standard, and with the bi-predicted video frame packets including B-frame video packets according to the MPEG standard.

The payload of the second transport stream packet may include a packetized elementary stream header of the independently coded video frame packet and initial data of the independently coded video frame packet. In addition, a third flag value may be set in a header of a third transport stream packet indicating that the third transport stream packet includes subsequent data of the independently coded video frame packet, with the third flag value being different than the first and second flag values. A payload of the third transport stream packet may be selectively encrypted without encrypting the header of the third transport stream packet.

Each of the first, second, and third flag values may be set in a transport control scrambling field of the respective header.

The initial data of the independently coded video frame packet and the subsequent data of the independent coded video frame packet may include initial and subsequent data of the same independently coded video frame packet.

A packetized elementary stream of audio packets may be multiplexed with the packetized elementary stream of video frame packets onto the transport stream.

According to still other embodiments, an encryption system may include a memory storing a transport stream of a content file including a plurality of transport stream packets wherein a packetized elementary stream of video frame packets including independently coded and dependently coded video frame packets is multiplexed onto the transport stream, and a processor coupled with the memory. The processor may be configured to set a first flag value in a header of a first transport stream packet of the transport stream to indicate that the first transport stream packet does not include data of an independently coded video frame packet, and to set a second flag value in a header of a second transport stream packet of the transport stream to indicate that the second transport stream packet includes data of an independently coded video frame packet, with the first and second flag values being different. In addition, the processor may be configured to selectively encrypt a payload of the second transport stream packet without encrypting the header of the first transport stream packet. For example, a transport scrambling control flag in a header of each transport stream (TS) packet may be set to “11” if the TS packet includes the beginning of an independently coded video frame packet (e.g., an I-frame), to “10” if the TS packet includes other parts of an independently coded video frame packet, and to “00” for all other TS packets.

### BRIEF DESCRIPTION OF DRAWINGS

The accompanying drawings, which are included to provide a further understanding of the disclosure and are incorporated in and constitute a part of this application, illustrate certain non-limiting embodiment(s) of inventive concepts. In the drawings:

FIG. 1 is a block diagram illustrating elements of an entertainment system according to some embodiments of inventive concepts;

FIG. 2 is a block diagram illustrating a head end content server of FIG. 1 according to some embodiments of inventive concepts;

FIG. 3 is a block diagram illustrating a seat video display unit of FIG. 1 according to some embodiments of inventive concepts;

FIG. 4 is a block diagram illustrating an encryption system according to some embodiments of inventive concepts;

FIG. 5 is a schematic diagram illustrating encryption as used according to some embodiments of inventive concepts;

FIG. 6 is a block diagram illustrating an MPEG-2 Transport Stream (TS) packet as used according to some embodiments of inventive concepts;

FIG. 7 is a block diagram illustrating a breakdown of a payload of a TS packet of FIG. 6 into a PES packet header and PES packet data as used according to some embodiments of inventive concepts;

FIG. 8 is a block diagram illustrating elements of a header of a TS packet of FIG. 6 as used according to some embodiments of inventive concepts;

FIG. 9 is a schematic diagram illustrating decryption as used according to some embodiments of inventive concepts;

FIG. 10 is a schematic diagram illustrating I-frames (I1), B-frames (B2, B3, B5, B6, B8, B9, B11, and B12), and P-frames (P4, P7, and P10) as used according to some embodiments of inventive concepts;

FIGS. 11 and 12 are flow charts illustrating operations of encryption systems of FIGS. 4 and 5 according to some embodiments of inventive concepts;

FIG. 13 is a flow chart illustrating operations of servers of FIG. 2 according to some embodiments of inventive concepts;

FIG. 14 is a flow chart illustrating operations of display units of FIG. 3 according to some embodiments of inventive concepts; and

FIG. 15 is a block diagram illustrating a video frame packets of a packetized elementary stream multiplexed onto packets of a transport stream.

### DETAILED DESCRIPTION

In the following detailed description, numerous specific details are set forth in order to provide a thorough understanding of inventive concepts. However, it will be understood by those skilled in the art that present inventive concepts may be practiced without these specific details. In other instances, well-known methods, procedures, components and circuits have not been described in detail so as not to obscure present inventive concepts.

Although various embodiments of present inventive concepts are explained herein in the context of an in-flight entertainment environment, embodiments of entertainment systems and related displays/servers are not limited thereto and may be used in other environments, including other vehicles such as ships, buses, trains, and automobiles, as well as buildings such as conference centers, restaurants, businesses, hotels, homes, etc.

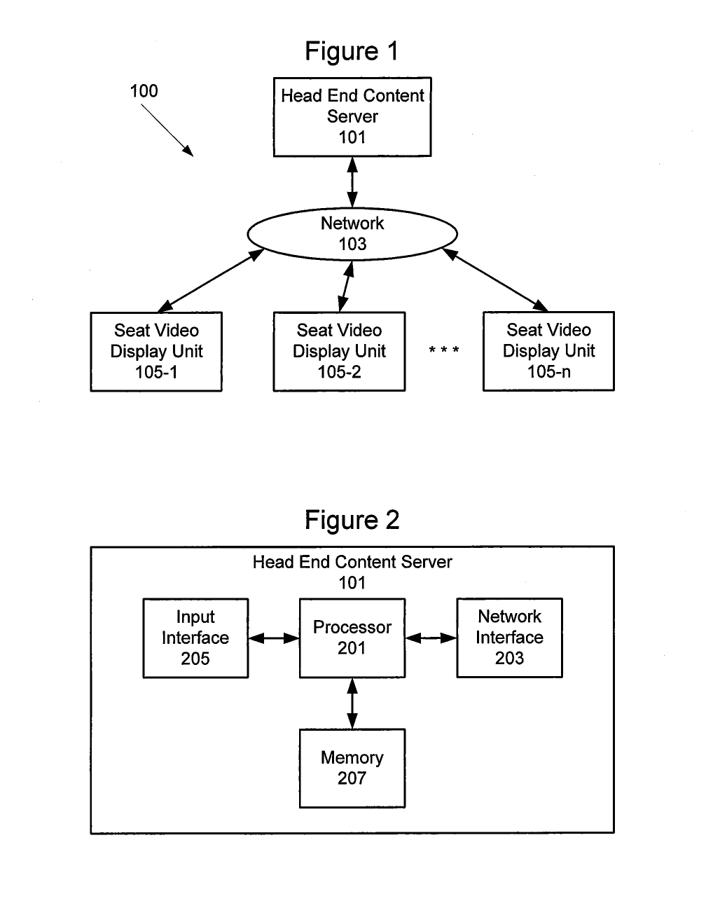

FIG. 1 is a block diagram of entertainment system 100 according to some embodiments of inventive concepts. The entertainment system may include head end content server 101, network 103, and seat video display units (SVDUs) 105-1 to 105-n configured according to some embodiments of present inventive concepts. Head end content server 101 may contain content (e.g., movies, television programs, other video, audio programs, music, application/game programs, etc.) that can be streamed or downloaded to SVDUs 105 through data network 103. Network 103 may provide communication between head end content server 101 and seat video display units 105 via wired (e.g., Ethernet) and/or wireless (e.g., IEEE 802.11, WiMax, Bluetooth, etc.) connection(s). While not shown separately in FIG. 1, network 103 may include seat electronics boxes providing distribution/collection of signaling between head end content server 101 and a subset of seat video display units. A seat electronics box, may be provided, for example, for a group of seats of a row between an aisle and a window and/or for a group of seats between aisles or can be included in the SVDU itself.

When used in an aircraft environment, each SVDU 105-1 to 105-n may be attached to a respective seatback so that each SVDU faces a respective passenger in a following row of seats. A user interface for an SVDU may be provided through a touch sensitive screen of the SVDU, through a keypad of the SVDU, and/or through a remote control unit coupled with the SVDU through a wired and/or wireless coupling. Each SVDU may thus receive user input (also referred to as user commands) via a user interface, for example, to control content selection, play, stop, volume control, brightness control, and/or trick mode operations (e.g., fast forward, fast rewind, and/or random access).

FIG. 2 is a block diagram illustrating head end content server 101 according to some embodiments of inventive concepts. As shown, head end content server 101 (also referred to as a server) may include memory 207 configured to store digital media (e.g., movies, television programs, other video, audio programs, music, application/game programs, etc.) to be streamed on-demand to respective seat video display units 105, a network interface 203 configured to provide a data coupling between server 101 and seat video display units 105 over network 103, and a processor 201 coupled to memory 207 and network interface 203. Processor 201 may thus be configured to control distribution of digital media from memory 207 through network interface 203 to seat video display units 105 responsive to user input received from/through the respective video display units 105.

In addition, server 101 may include an input interface 205 coupled to processor 201 where input interface 205 is configured to receive the digital media that is stored in memory 207. The digital media stored in memory 207 may thus be updated/replaced periodically (e.g., monthly) to provide new/current programming. Input interface 205, for example, may be a port providing a detachable coupling to a wired network and/or external storage device/drive, a disk drive configured to read data from a removable disk, a wireless network interface, etc. According to some embodiments, separate input and network interfaces may not be needed if both interfaces operate according to a same wireless/wired network standard. While not shown separately in FIG. 2, server 101 may also include a user interface coupled to processor 201, where the user interface is configured to accept user input to control operation of server 101. Such user input may be used to control deletion of media content from memory 207, download of media content through input interface 205 to memory 207, system operating parameters, etc.

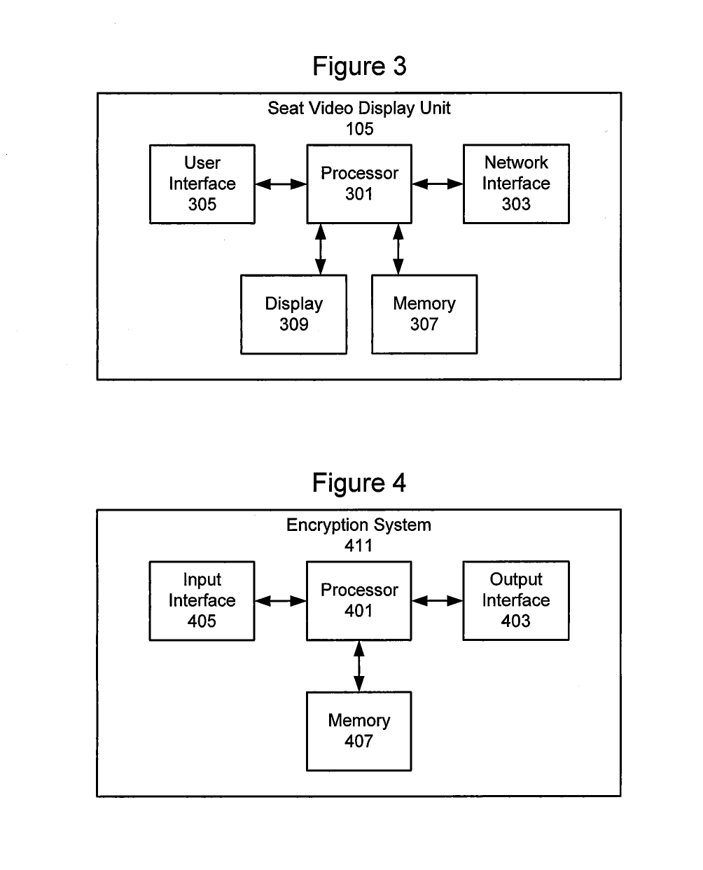

FIG. 3 is a block diagram illustrating seat video display unit SVDU 105 (also referred to as a display unit) according to some embodiments of inventive concepts. As shown, display unit 105 may include memory 307 configured to buffer/store digital media (e.g., movies, television programs, other video, audio programs, music, application/game programs, etc.) to be presented on display unit 105, a network interface 303 configured to provide a data coupling between server 101 and display unit 105 over network 103, and a processor 301 coupled to memory 307 and network interface 303. Display unit 105 may include user interface 305 and display 309 coupled to processor 301. Processor 301 may thus be configured to control presentation of digital media on display 309 responsive to user input received through user interface 305.

User interface 305 may be provided as a touch screen (so that user interface 305 and display 309 are integrated), a keypad on and/or coupled to the display unit 105, and/or an interface (wired or wireless) to a remote control unit. Processor 301 may thus control content selection, play, stop, volume control, brightness control, and/or trick mode operations (e.g., fast forward, fast rewind, and/or random access) responsive to user input through user interface 305.

According to some embodiments, encrypted digital media content may be stored at memory 207 of server 101 and streamed as an encrypted transport stream through network interface 204 over network 103 to display unit 105. At display unit 105, the encrypted transport stream is received through network interface 303 and processed by processor 301 for presentation on display 309. According to some other embodiments, encrypted digital media content may be stored at memory 307 of display unit 105 and processed by processor 301 for presentation on display 309. According to some hybrid embodiments, digital media content that is expected to be used most frequently (e.g., recently released movies) may be stored in memory 307 at each display unit 105, while digital media content that is expected to be used less frequently (e.g., classic movies) may be stored in memory 207 at server 101. Whether digital media is stored at server 101 or at display unit 105, processor 301 may process (decrypt and decode) the digital media for presentation on display 309.

FIG. 4 is a block diagram illustrating an encryption system 411 configured to encrypt digital media for use by system 100 of FIGS. 1, 2, and 3. As shown, encryption system 411 may include input interface 405, output interface 403, and memory 407, all coupled to processor 401. Input interface 405 may be configured to receive digital media content from a content service provider (CSP). Input interface 405, for example, may include a disk drive configured to read a removable disk on which digital media content is stored, a port configured to receive digital media content from an external storage device and/or a network, a wireless interface configured to receive the digital media content wirelessly, etc. Output interface 403 may include a disk drive configured to write encrypted digital media content to a removable disk, a port configured to transmit encrypted digital media content to an external storage device via a detachable coupling, etc. Processor 401 is thus configured to receive digital media content from a CSP through input interface 405, to encrypt the digital media content, and to write the encrypted digital media content (using output interface 405) onto a storage medium (e.g., a disk) for transfer to the entertainment system 100 of FIG. 1. Output interface 403 of encryption system 411 and input interface 205 of server 101 may thus be compatible so that output interface 403 and input interface 205 are respectively configured to write to and read from the same storage medium and/or communicate over a network.

According to some embodiments of inventive concepts, an MPEG-2 TS file may be re-processed using encryption system 411 of FIG. 4 before shipping for use by entertainment system 100 of FIG. 1. Processor 401 may start with a plaintext (unencrypted) MPEG-2 Transport Stream (TS). For example, a plaintext MPEG-2 TS may be received from the CSP at processor 401 through input interface 405 so that decryption is not required at encryption system 411. According to some other embodiments, an encrypted MPEG-2 TS may be received from the CSP at processor 401 through input interface 405, and processor 401 may decrypt the transport stream before performing encryption according to embodiments of inventive concepts. Stated in other words, the CSP may provide the transport stream using a form of encryption that is incompatible with entertainment system 100 so that processor 401 decrypts the original transport stream before encrypting the transport stream using encryption according to embodiments of inventive concepts that are compatible for use with entertainment system 100. Starting from the plaintext MPEG-2 TS, the following operations may be performed by processor 401:
1. Find each MPEG-2 TS packet containing I-Frame data,
2. Encrypt each MPEG-2 TS packet payload containing I-frame data,
3. Add flags in the corresponding MPEG-2 TS headers containing I-Frame data, and
4. Perform QA (Quality Assurance) to insure that the encryption is correct.

Encryption/decryption time may be reduced/minimized by only encrypting packet payloads including I-Frame data compared with encryption time needed to encrypt whole video PES file payloads. Encryption of only packets including I-Frame payloads may provide the same result as encrypting all video PES file payloads which is that none of the decoded video frames resemble any of the original frames. Encryption of other frames (i.e., P-frames and B-frames) is unnecessary because correct decoding/computation of these frames is not possible without correctly decoding the respective I-Frames. Stated in other words, the plaintext I-Frame data (i.e., generated by decrypting the encrypted I-Frame data) is required to correctly decode the B-Frame and P-Frame data.

By reducing decryption, the CPU time required by processor 301 of display unit 105 for decryption can be reduced, thereby reducing processing overhead and/or CPU requirements at display unit 105. Client display unit 105 (e.g., an MPEG player) may thus require fewer resources to display a decrypted motion picture.

The encrypted file may be more resilient to network errors, because the encryption may be restarted for each I-frame. Lost data may only affect one I-frame instead of the remainder of the video file as may be the case with file encryption using AES with CBC mode.

The MPEG-2 TS is not opened so that it may be simpler and/or more efficient because re-multiplexing of all elementary streams together may not be required later on. Quality Assurance QA may be simpler because the QA may verify encryption/decryption only without also verifying re-multiplexing.

The server 101 (also referred to as a streamer or streaming server) may provide trick mode operations quickly/immediately, while errors may be more likely to occur for IFESs where a corresponding index file of all I-Frame locations for each movie is used to provide trick mode capabilities. Use of a corresponding index file may also require synchronization of two files for each movie at each download interval (e.g., each month).

By having the locations of encrypted I-frames flagged in the MPEG-2 TS headers of the encrypted transport stream, server processor 201 may need only to find these flags and send these encrypted I-frame packets during trick mode operations. Trick mode operations may thus be performed more efficiently while maintaining encryption. Methods according to some embodiments disclosed herein may permit server processor 201 to save time while searching for a next I-frame to be sent out, and therefore, can process more trick mode streams simultaneously (e.g., for multiple display units). Other encryption schemes may need a way to find I-frame packets, such as using a pre-processed I-frame packet location index file or direct location by parsing the Video PES headers and looking for I-Frames (possibly requiring relatively large computations that may reduce a number of simultaneous trick mode operations).

An I-Frame packet location index file per movie may not be needed to allow for trick mode operations using encryption according to some embodiments of inventive concepts. Digital media content stored in server memory 207 may change on a monthly basis and any video frame index files would also need to be provided each month or each time a server is replaced. Therefore, memory space used to store encrypted content according to embodiments disclosed herein may be reduced by not requiring such video frame index files.

In addition, an encrypted file according to embodiments of inventive concepts may have exactly/substantially a same length as the original (unencrypted) file from which the encrypted file was generated.

According to embodiments of inventive concepts, encryption system processor 401 generates an encoded MPEG transport stream (TS), where payloads of packets including I-frame data are encrypted while payloads of packets including P-frame data and/or B-frame data without I-frame data remain unencrypted. Packets of the transport stream are identified using 2 bits of the MPEG format that are reserved for “Transport Scrambling Control” in the Transport Packet Header. In the encoded transport stream, these 2 bits may be set to “11” for transport stream packets containing initial data of an I-frame (and also containing a PES packet header for the I-frame), to “10” for transport stream packets containing a subsequent data of an I-frame (without a PES packet header for the I-frame), and to “00” for all other TS packets (i.e., for packets without I-frame data).

Encryption typically used in the IFEC industry is AES (Advanced Encryption Standard) encryption using 128-bit symmetric key with Cypher Block Chaining (CBC). According to some embodiments disclosed herein, the last 176 bytes of any payload containing I-frame data is encrypted, and because this is a multiple of 16, no padding may be required. In contrast, block cipher modes may operate on whole blocks and may require that the last part of the data be padded to a full block if it is smaller than the current block size.

According to some embodiments of inventive concepts, because no extra bytes are added, file size and stream bit rate may remain the same between the non-encrypted version of the digital media content (received at encryption system interface 405) and the encrypted version of the same content (provided at encryption system output interface 403).

Moreover, quality assurance (QA) of an encrypted file may be easier to perform when the corresponding unencrypted file and encrypted file have the same size because the decrypted file can be bit-by-bit compared to the original file. In systems where padding bits are added by CBC encryption and/or where additional bits are added to the packet header, any padding bits and/or other additional bits in the header may have to be removed (or otherwise accounted for) before performing any comparison with the original file.

According to some embodiments disclosed herein, transport-level encryption may be provided by encryption system processor 401 such that some MPEG-2 TS packet payloads are selectively encrypted based on their content type (e.g., including I-frame data). Other content types (e.g., P-frames and/or B-frames) may be partially encrypted too if portions thereof are included in a same MPEG-2 TS packet payload as I-frame data, but MPEG-2 TS packet payloads without I-frame data may remain unencrypted.

When performing decryption at a receiving SVDU 105, display unit processor 301 may have more time to eliminate non I-frame data after decryption than the server, because a head end content server may have to stream as many video streams, audio streams and trick streams as possible. Server processor 201 may thus detect I-frames at the MPEG-2 TS packet header level to reduce processing overhead at server 101 during trick mode operations.

According to some embodiments of inventive concepts, wasted space at server memory 207 (e.g., server HDDs/SSDs) may be reduced because padding and/or index files may not be needed.

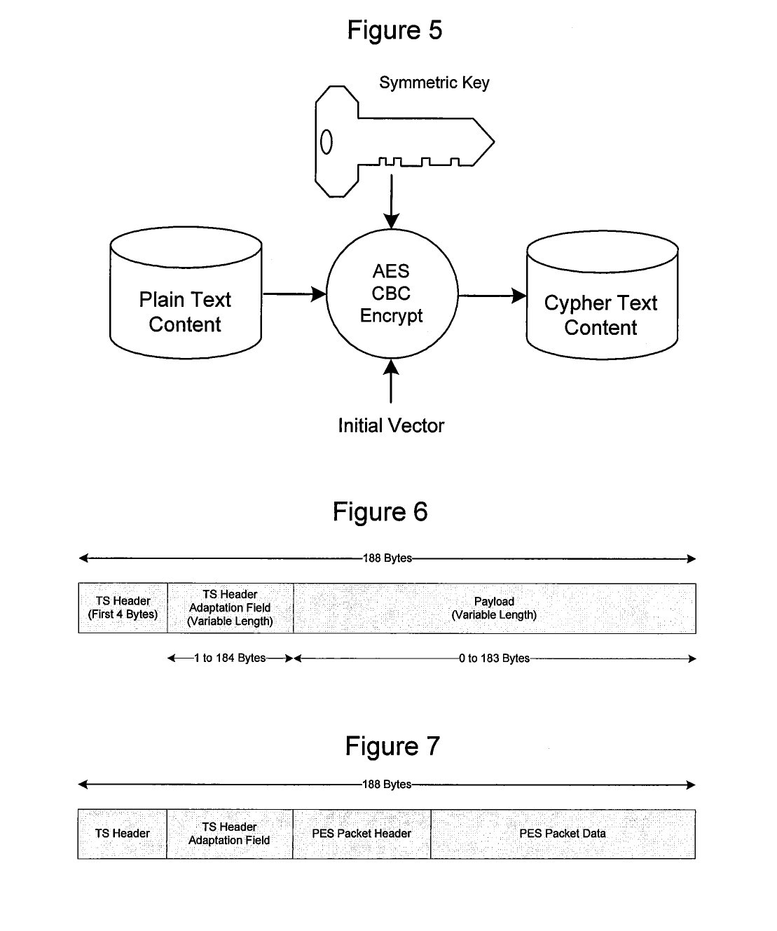

FIG. 5 is a schematic diagram illustrating AES encryption using CBC Mode encryption as selectively performed by processor 401 of encryption system 411 of FIG. 4 on payloads of TS packets including I-frame data.

FIG. 6 is a block diagram illustrating a structure of an MPEG-2 TS packet. The TS packet may include a TS header (first 4 bytes), a TS header adaption field (Variable length between/including 1 and 184 bytes), and a payload (variable length between/including 0 and 183 bytes). Each TS packet may have a length of 188 bytes.

FIG. 7 is a block diagram illustrating an MPEG-2 TS packet including a start of a PES packet. A packet of PES data may be larger than the available payload of one TS packet, so that multiple TS packets are required to transmit the data of one PES packet. A PES packet header may be provided for each PES packet. Accordingly, the PES packet header and initial data of the PES packet may be included in a first TS packet of the PES packet, and the remainder of the data of the PES packet may be included in subsequent TS packets without a/the PES packet header. Accordingly, a PES packet data may be transported through several MPEG-2 TS packets.

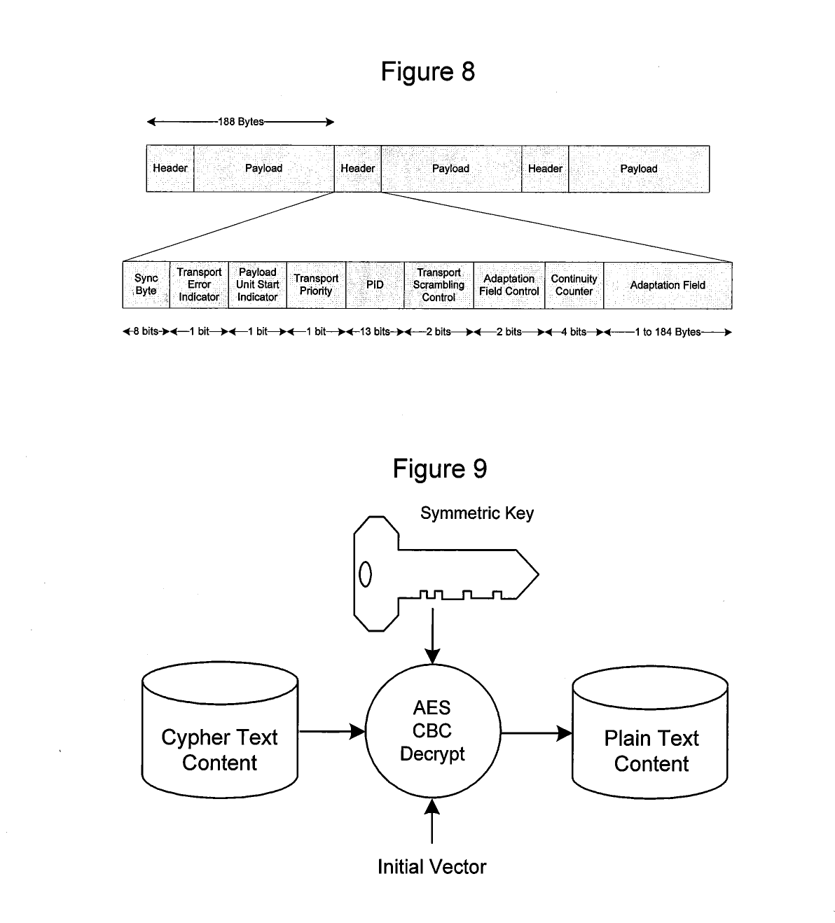

FIG. 8 is a block diagram illustrating elements of an MPEG-2 TS packet header in greater detail. As shown, each 188 byte TS packet header includes sync byte (8 bits), transport error indicator (1 bit), payload unit start indicator (1 bit), a transport priority (1 bit), a Packet Identification or PID (13 bits), transport scrambling control (2 bits), adaptation field control (2 bits), continuity counter (4 bits), and variable length adaption field (1 to 184 bytes).

FIG. 9 is a schematic diagram illustrating AES decryption using CBC mode encryption performed by processor 301 of display unit 105.

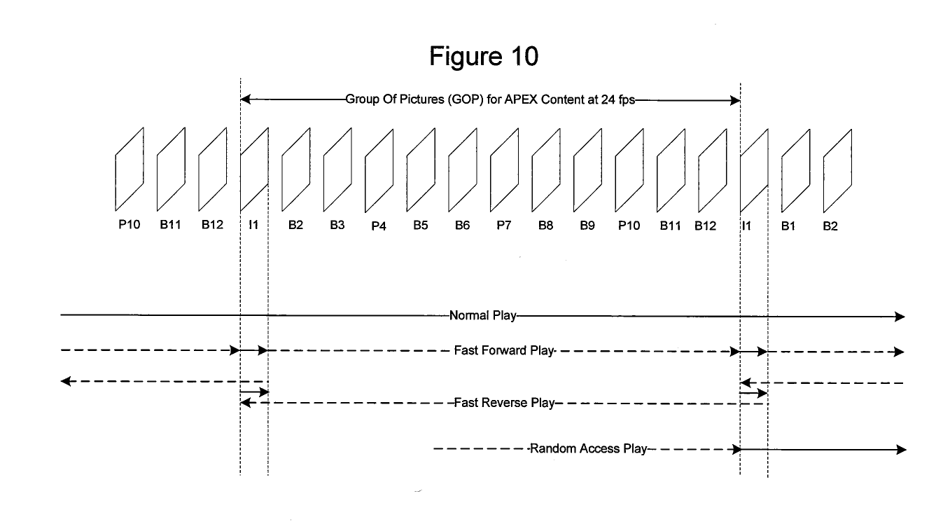

FIG. 10 is a schematic diagram illustrating an ordering sequence of video I-frames, P-frames, and B-frames to display (in the order to be displayed). FIG. 10 also illustrates use of I-frames only for trick mode operations according to some embodiments disclosed herein. At 24 frames per second (fps) according to MPEG-2 formats, one video I-frame (I1) is provided every twelfth video frame in a 12 frame Group of Pictures (GOP). After each video I-frame I1 in a 12 frame GOP, 9 B-frames (B2, B3, B5, B6, B8, B9, B11, and B12) and 3 P-frames (P4, P7, and P10) follow in the order indicated in FIG. 10. As shown in FIG. 10, a 12 frame Group of Pictures (GOP) may thus include the following frames in the display order indicated: video I-frame I1, video B-frame B2, video B-frame B3, video P-frame P4, video B-frame B5, video B-frame B6, video P-frame P7, video B-frame B8, video B-frame B-9, video P-frame P10, video B-frame B11, and video B-frame B12.

Each video I-frame (also referred to as an intra coded frame or key frame) may be completely self referential meaning that a video I-frame does not use information from any other frames for decoding/reconstruction. Stated in other words, a video I-frame is intra coded and can thus be decoded/reconstructed without reference to any other frame(s). In contrast, P-frames and B-frames are inter coded so that decoding/reconstructions of a video P-frame and/or a video B-frame requires reference to at least one other video frame.

Each video P-frame (also referred to as a predicted frame) is forward predicted using the most recent previous video I-frame or P-frame for decoding/reconstruction. A video P-frame is thus decoded/reconstructed using the most recently preceding video I-frame or P-frame. For example, video P-frame P4 is decoded/reconstructed using information from frames I1 and P4; video P-frame P7 is decoded/reconstructed using information from frames P4 and P7; and video P-frame P10 is decoded/reconstructed using information from frames P7 and P10. Accordingly, none of the P-frames in a 12 frame GOP can be decoded/reconstructed until the video I-frame I1 of the GOP has been decrypted.

Each video B-frame (also referred to as a bi-directional predicted frame) is forward and backward predicted using the most recent previous video I-frame or P-frame and the next subsequent P-frame or I-frame for decoding/reconstruction. A video B-frame is thus decoded/reconstructed using preceding and following video I/P-frames. For example, video B-frame B2 is decoded/reconstructed using information from frames I1, B2, and P4; video B-frame B3 is decoded/reconstructed using information from frames I1, B3, and P4; video B-frame B5 is decoded/reconstructed using information from frames P4, B5, and P7; video B-frame B6 is decoded/reconstructed using information from frames P4, B6, and P7; video B-frame B8 is decoded/reconstructed using information from frames P7, B8, and P10; video B-frame B9 is decoded/reconstructed using information from frames P7, B9, and P10; video B-frame B11 is decoded/reconstructed using information from frames P10, B11, and I1 (of the next GOP); and video B-frame B12 is decoded/reconstructed using information from frames P10, B12, and I1 (of the next GOP). Accordingly, none of the B-frames in a 12 frame GOP can be decoded/reconstructed until the video I-frame I1 of the GOP has been decrypted.

MPEG video compression and frame construction is discussed, for example, in “MPEG Video Compression Technique” (https://vsr.informatik.tu-chemnitz.de/˜jan/MPEG/HTML/mpeg_tech.html), reproduced Oct. 3, 2014; and in “Understanding H.264 Encoding Parameters—I, P and B-frames,” Streaming Learning Center (http://www.streaminglearningcenter.com/articles/producing-h264-video-for-an-overview), reproduced Oct. 3, 2014), reproduced Oct. 3, 2014. The disclosures of both of these references are hereby incorporated herein in their entireties by reference.

In order to reproduce video content on display 309 during normal play operations, processor 301 should thus decrypt each video I-frame, decode each video I-frame, and decode each video P-frame and B-frame of each GOP. Each video frame (including I-, P-, and B-frames) can be rendered/reproduced on display 309 at a rate of 24 frames per second to play the video. For trick mode operations, only the video I-frames may be decrypted and decoded to provide fast forward, fast reverse, and/or random access. Fast forward/reverse can be provided, for example, as follows: by selecting every second next/previous I-frame for 2 times (2×) normal speed; by selecting every fourth next/previous I-frame for 4 times (4×) normal speed; by selecting every eighth next/previous I-frame for 8 times (8×) normal speed; by selecting every sixteenth next/previous I-frame for 16 times (16×) normal speed; by selecting every thirty second next/previous I-frame for 32 times (32×) normal speed; and by selecting every sixty fourth next/previous I-frame for 64 times (64×) normal speed.

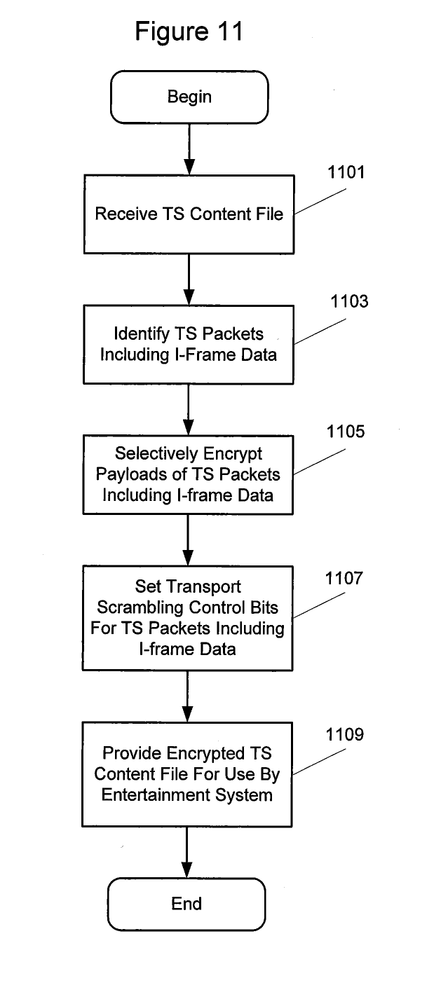

Operations of encryption system 411 are discussed with reference to the flow chart of FIG. 11. According to some embodiments of inventive concepts, an MPEG-2 TS content file is received by encryption system 411 of FIG. 4 at block 1101. The MPEG-2 TS content file may be received as plain text content. As discussed above, the MPEG-2 TS content file may be received at processor 401 through input interface 405 where input interface 405, for example, may be a port and/or wireless interface configured to receive the TS content file from a network and/or external storage device over a wired and/or wireless interface, or a disk drive configured to read the TS content file from a removable disk. Processor 401 may then identify TS packets (of the TS content file) including I-frame data at block 1103 by parsing video PES headers (see, FIGS. 6 and 7).

For each TS packet that is identified as including I-frame data at block 1103, processor 401 selectively encrypts the whole payload of the identified MPEG-2 TS packets including I-frame data at block 1105. For example, payloads may be encrypted using Advanced Encryption Standard (AES) encryption with a 128-bit symmetric key (16 bytes) using Cypher Block Chaining (CBC) with an Initialization Vector (16 bytes).

As discussed above, a video I-frame may occupy all or portions of payloads of multiple consecutive TS packets of the TS content file. A last portion of a video I-frame may not completely occupy a payload of a last TS packet used to transport the video I-frame, and portions of a video P-frame and/or B-frame may also be included in the last TS packet used to transport the video I-frame. Encryption of payloads including I-frame data may be performed as discussed above with respect to FIG. 5 using AES CBC encryption with an initial vector and a symmetric key.

Accordingly, for any MPEG-2 TS packet payload that includes I-frame data (partial or full payload), the complete packet payload is encrypted (more precisely, the last 176 bytes in order to not encrypt the packet header). Padding is not needed. The first block size of 16 bytes is encrypted, then the next block size of 16 bytes is encrypted, and each next block size of 16 bytes is encrypted until there are no blocks left in the payload to encrypt. By encrypting each full 16 byte block of the payload, all I-frame slices and a little more (e.g., a portion of a next B-frame) may be encrypted if the payload includes the end of an I-frame.

For each TS packet that is identified as including I-frame data at block 1103, processor 401 may also set the “Transport Scrambling Control” (2 bits) flags in the MPEG-2 TS packet header (see, FIG. 8) at block 1107 to indicate that its payload is encrypted. For example, Transport Scrambling Control bits may be set as follows: to “11” for transport stream packets including initial data of an I-frame (and thus also including a PES packet header for the I-frame); to “10” for transport stream packets including subsequent data of an I-frame; and to “00” for all other TS packets (i.e., for packets without I-frame data).

At block 1109, the resulting encrypted TS content file is provided as cipher text content for use by entertainment system 100. Processor 401, for example, may use output interface 403 (e.g., a disk drive) to write the encrypted TS content file to a removable disk, and/or processor 401 may use output interface 403 (e.g., a wired/wireless network interface) to transmit the encrypted TS content file to entertainment system 100 (e.g., using secure transmission). In the resulting encrypted TS content file, none of the TS headers or TS header adaptation fields are encrypted. Only payloads of TS packets including I-frame data are encrypted, and these packets are identified using flags in the Transport Scrambling Control field in the TS packet header.

At entertainment system 100, the encrypted TS content file can be streamed from head end server 101 through network 103 to a display unit 105 for presentation of the video on display 309. For normal play, server 101 can stream all TS packets to display unit 105, and processor 301 can use the transport scrambling control flags to determine which TS packets require decryption and which TS packets do not require decryption. During trick mode operations, server 101 may transmit only encrypted TS packets based on the transport scrambling control flags.

At display unit 105, processor 301 may thus selectively decrypt only encrypted TS packets including I-frame data based on the transport scrambling code flags, without decrypting other non-encrypted TS packets. Processor 301 may decrypt the encrypted TS packets using an Advanced Encryption Standard (AES) 128-bit symmetric key (16 bytes) with Cypher Bock Chaining (CBC) decryption with an initial vector (16 byte), corresponding to that used for encryption. Processor 301 may then demultiplex and decode the PESs for presentation of the video on display 309.

The encrypted MPEG-2 Transport Stream may then be saved at memory 207 of head end content server 101 and/or memory 307 of seat video display unit 105. Head end content server 101 and/or seat video display unit 105 may thus stream unencrypted or encrypted Standard Definition (SD) and High Definition (HD) content the same way.

For trick mode operations when streaming unencrypted content, server processor 201 and/or SVDU processor 301 (if the content is stored at SVDU memory 307) looks for the first I-frame header parsing PES packets and sends a number of MPEG-2 TS packets estimated to include a whole I-frame to SVDU processor 301. Based on the speed of Fast Forward/Reverse requested by SVDU 105, for example, server processor 201 (and/or SVDU processor 301 if the content is stored in SVDU memory 307) may identify every second next/previous I-frame for 2 times normal speed (2× normal speed), every fourth next/previous I-frame for four times normal speed (4× normal speed), every eighth next/previous I-frame for eight times normal speed (8× normal speed), every sixteenth next/previous I-frame for sixteen times normal speed (16× normal speed), every thirty second next/previous I-frame for thirty two times normal speed (32× normal speed), and every sixty fourth next/previous I-frame for sixty four time normal speed (64× normal speed). Server processor 201 (and/or SVDU processor 301 if the content is stored in SVDU memory 307) may then send each identified TS packet together with a number of subsequent MPEG-2 TS packets including the complete I-Frame.

For trick mode operations when streaming encrypted content, server processor 201 (and/or SVDU processor 301 if the content is stored at SVDU memory 307) looks for the flagged headers of the MPEG-2 TS packets that identify TS packets including encrypted I-frame data. Based on the speed of fast forward/reverse requested by SVDU 105, for example, processor 201/301 may identify every second next/previous I-frame for two times normal speed (2× normal speed), every fourth next/previous I-frame for four times normal speed (×4 normal speed), every eighth next/previous I-frame for eight time normal speed (8× normal speed), every sixteenth next/previous I-frame for sixteen time normal speed (16× normal speed), every thirty second next/previous I-frame for thirty two times normal speed (32× normal speed), and/every sixth fourth next/previous I-frame for sixty four times normal speed (64× normal speed), and send the identified I-frame packets to SVDU processor 301 for decryption/decoding.

SVDU processor 301 may thus use the encryption flags in the TS packet headers to determine which TS packets should be subject to decryption. If the encryption flag of a TS packet header does not indicate encryption (e.g., “00” in the Transport Control Scrambling field), SVDU processor 301 may decode the TS packet payload without decryption. If the encryption flag of a TS packet header indicates encryption (e.g., “11” or “10” in the Transport Control Scrambling field), SVDU processor 301 may selectively decrypt the TS packet payload before decoding the payload. For example, SVDU processor 301 may selectively decrypt the encrypted packet payloads using Advanced Encryption Standard (AES) using the same 128-bit symmetric key with Cypher Block Chaining (CBC) that was used by encryption system 411 to encrypt the Transport Stream as discussed above with respect to FIGS. 5 and 9. Accordingly, the same symmetric key (16 Bytes) and the same Initialization Vector (IV) (16 Bytes) that was used by encryption system 411 to encrypt the Transport Stream is provided to SVDU processor 301 to decrypt the Transport Stream.

Any MPEG-2 TS packet payload than includes I-frame data (partial or in full) is thus decrypted by SVDU processor 301. There is no padding to remove from encrypted payloads, and SVDU processor 301 starts with the first block size of 16 bytes of the last 176 bytes of the encrypted payload and decrypts it, then proceeds to the next block size of 16 bytes of the encrypted payload and decrypts it, and so on, until there are no more bytes to decrypt. By decrypting the flagged TS packets, I-frame slices of the TS packet may be decrypted, and a little more (e.g., a next B-Frame) may also be decrypted if the MPEG-2 TS packet payload contains the end of an I-Frame.

In the header of the MPEG-2 TS packet (188 Bytes packets), the “Transport Scrambling Control” (2 bits) field may be used to provide flags which indicate Encryption and I-frame slices. These 2 bits are not currently used in content encoded for In-Flight Entertainment Systems, and this field can thus be used to indicate that there is a PES packet that is encrypted and contains an I-frame/slice.

According to some embodiments, all TS packets that contain a PES packet with an I-frame/slice that is encrypted may be flagged using the bits “11” in the TS header “Transport Scrambling Control” bits, and all other TS packets without I-frame data may be flagged using the bits “00” in the TS header “Transport Scrambling Control” bits.

According to some other embodiments, all TS packets that contain a PES packet with initial data of an I-frame/slice that is encrypted (including a PES packet header for the I-frame) may be flagged using the bits “11” in the TS header “Transport Scrambling Control” bits, all TS packets that contain a PES packet with subsequent (non-initial) data of an I-frame/slice that is encrypted (without a PES packet header for the I-frame) may be flagged using the bits “10” in the TS header “Transport Scrambling Control” bits, and all other TS packets without I-frame data may be flagged using the bits “00” in the TS header “Transport Scrambling Control” bits.

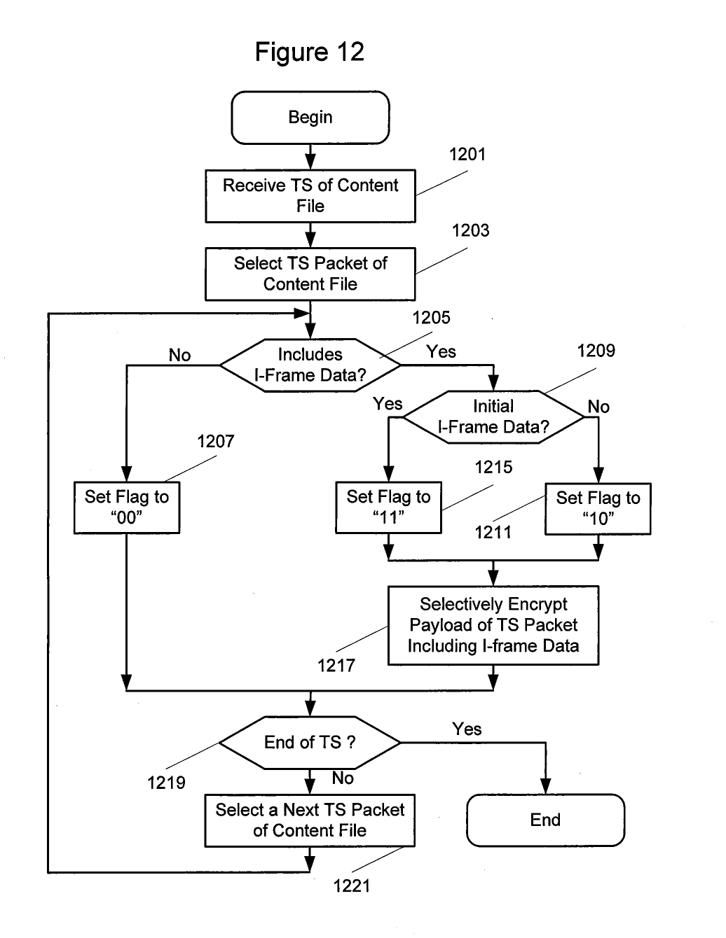

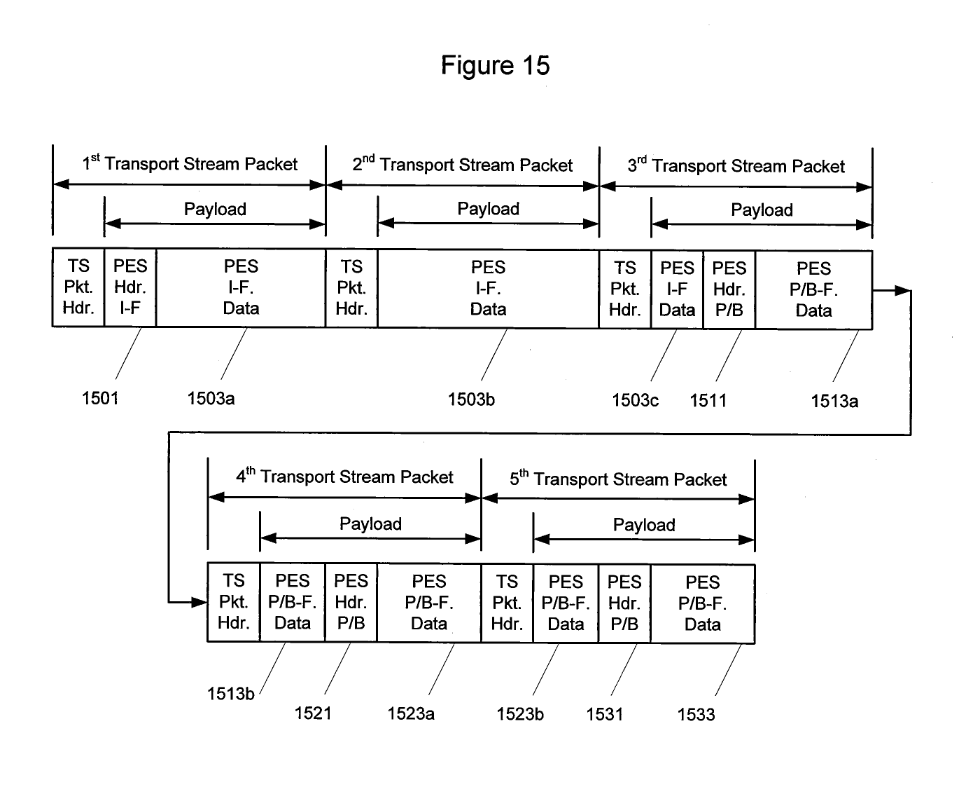

Encryption, streaming, and decrypting operations of encryption system 411, head end content server 101, and seat video display unit 105 are discussed in greater detail below with respect to the flog charts of FIGS. 12, 13, and 14, and with respect to the transport stream packets illustrated in FIG. 15. FIG. 15 illustrates 1^{st}, 2^{nd}, 3^{rd}, 4^{th}, and 5^{th} transport stream TS packets, each of which includes a respective TS packet header (TS Pkt. Hdr.) and payload. As shown, video frame packets of a packetized elementary stream PES are multiplexed onto the transport stream. For example, an independently coded video frame packet (e.g., an I-frame video packet) may include PES header 1501 and PES data 1503a, 1503b, and 1503c that are included in payloads of the 1^{st}, 2^{nd}, and 3^{rd} transport stream packets; a first dependently coded video frame packet (e.g., a P-frame or a B-frame video packet) may include PES header 1511 and PES data 1513a and 1513b that are included in payloads of the 3^{rd} and 4^{th} transport stream packets; a second dependently coded video frame packet (e.g., a P-frame or a B-frame video packet) may include PES header 1521 and PES data 1523a and 1523b that are included in payloads of the 4^{th} and 5^{th} transport stream packets; and a third dependently coded video frame packet (e.g., a P-frame or a B-frame video packet) may include PES header 1531 and PES data 1533a that are included in a payload of the 5^{th} transport stream packet. For example, the transport stream of FIG. 15 may be a MPEG-2 transport stream TS, and each transport stream packet may include a two bit transport scrambling control field (e.g., the 25^{th} and 26^{th} bits of the TS header) that is used to identify TS packets including data of independently coded video frame packets. While only 5 TS packets with portions of a packetized elementary stream PES of video data are shown in FIG. 15 for the purposes of illustration, other packetized elementary streams (e.g., for audio, closed caption, subtitles, etc.) may be multiplexed onto the transport stream.

While FIG. 15 shows five TS packets (with the first TS packet including portions of an independently coded video frame packet), the transport stream may include many TS packets preceding the 1^{st} TS packet and/or many TS packets following the 5^{th} TS packet. Moreover, TS packets preceding the first TS packet may include data of dependently and/or independently coded video frame packets, and/or TS packets following the 5^{th} TS packet may include headers/data of independently and/or dependently coded video frame packets.

Operations of encryption system 411 of FIG. 4 according to some embodiments will be discussed in greater detail below with respect to FIG. 12. At block 1201, processor 401 may receive a transport stream TS of a content file through input interface 405 (e.g., including the TS packets of FIG. 15), and the transport stream TS may include a plurality of transport stream packets. In addition, a packetized elementary stream of video frame packets (including independently coded and dependently coded video frame packets) may be multiplexed onto the transport stream. For example, input interface 405 may be a network interface, with the transport stream TS being received over a network from a CSP, or input interface may be a port/drive configured to receive/read the transport stream from a memory media such as a disk, disk drive, flash memory, etc. Moreover, the processor 401 may be configured to store the transport stream in memory 407 in a plaintext format (without encryption). If the transport stream is initially received with encryption, processor 401 may decrypt the transport stream before saving to memory 407.

In addition to the packetized elementary stream of video frame packets, the transport stream may include other packetized elementary streams multiplexed onto the transport stream. For example, a packetized elementary stream of audio packets, a packetized elementary stream of closed caption packets, and/or one or more packetized elementary stream(s) of foreign language packets may be multiplexed onto the transport stream. The transport stream of the content file may thus provide video content (e.g., a movie, a television program, etc.) including video, audio, closed captioning, foreign language subtitles, etc.

Having received the transport stream at block 1201 and saved it to memory 407, processor 401 may select a transport stream packet of the content file (e.g., a first/initial TS packet) at block 1203. At block 1205, processor 401 may determine if the selected transport stream packet includes data of an independently coded video frame (e.g., an I-frame) packet. If the selected transport stream packet does not include data of an independently coded video frame packet (e.g., the 4^{th} and 5^{th} TS packets of FIG. 15), processor 401 may set a first flag value (e.g., “00”) in a header of the selected transport stream packet to indicate that the first transport stream packet does not include data of an independently coded video frame packet. More particularly, the first flag value may be set in a transport scrambling control TSC field of the header. Such transport stream packets may include data of dependently coded video frame packets (e.g., P-frames and/or B-frames), audio packets, closed caption packets, subtitle packets, etc. Moreover, the header field of a transport stream packet without data of an independently coded video frame packet may be set at block 1207 without encrypting a payload of the transport stream packet.

If the selected transport stream packet includes data of an independently coded video frame packet (e.g., 1^{st}, 2^{nd}, and 3^{rd} TS packets of FIG. 15), processor 401 may determine at block 1209 if the transport stream packet is an initial transport stream packet of an independently coded video frame packet (e.g., 1 TS packet including PES header 1501) or a subsequent transport stream packet of an independently coded video frame packet (e.g., 2^{nd} or 3^{rd} TS packets without a PES header for the independently coded video frame packet) at block 1209. For example, data 1503a, 1503b, and 1503c of one independently coded video frame packet (e.g., an I-frame) may be included in payloads of a plurality of sequential transport stream packets (e.g., in payloads of the 1^{st}, 2^{nd}, and 3^{rd} transport stream packets of FIG. 15), with a PES header 1501 and initial data 1503a of the independently coded video frame being included in an initial transport stream packet (e.g., the 1^{st} TS packet of FIG. 15) of the plurality of sequential transport stream packets, and with subsequent data 1503b and 1503c of the independently coded video frame being included on subsequent ones of the sequential transport stream packets (e.g., in the 2^{nd} and 3^{rd} TS packets of FIG. 15). Remaining data of the independently coded video frame packet may not fill a payload of a last of the sequential transport stream packets (e.g., the 3^{rd} TS packet), and a portion of a dependently coded video frame packet (e.g., PES header 1511 and data 1513a) may be included in the unfilled payload of the last of the sequential transport stream packets (e.g., in the 3^{rd} TS packet) used by the independently coded video frame packet.

If the transport stream packet is an initial transport stream packet (e.g., the 1^{st} TS packet of FIG. 15) of an independently coded video frame packet at block 1209, a second flag value (e.g., “11”) is set in a header of the initial transport stream packet (e.g., in the TS packet header of the 1^{st} TS packet) of the independently coded video frame packet at block 1215. The initial transport stream packet may be identified by the PES header 1501 for the independently coded video frame packet (which is not included in subsequent transport stream packets of the same independently coded video frame packet). If the transport stream packet (e.g., the 2^{nd} TS packet, or the 3^{rd} TS packet) is a subsequent transport stream packet of an independently coded video frame packet at block 1209, a third flag value (e.g., “10”) may be set in a header (e.g., the TS packet header of the 2^{nd} or 3^{rd} TS packet) of the subsequent transport stream packet of the independently coded video frame packet at block 1211. According to some other embodiments, a same flag value (e.g., “11”) may be set in the header of any initial or subsequent transport stream packet including data of an independently coded video frame packet.

If the selected transport stream packet includes data of an independently coded video frame packet (e.g., 1^{st}, 2^{nd}, and 3^{rd} TS packets of FIG. 15), processor 401 selectively encrypts a payload of the selected transport stream packet (e.g., the payload of the 1^{st}, 2^{nd}, and/or 3^{rd} TS packets including PES headers 1501 and/or 1511 and data 1503a, 1503b, 1503c, and/or 1513a) at block 1217 without encrypting the headers of the transport stream packets. The TS packet headers remain unencrypted whether the associated TS packet payload is encrypted or not.

Processor 401 may thus start at the beginning of a transport stream at block 1203, and proceed with blocks 1205 to 1217 as discussed above. After processing a selected TS packet, processor 401 may determine at block 1219 if all TS packets of the transport stream have been processed. If not, a next TS packet may be selected at block 1221, and operations of blocks 1205 to 1217 may be repeated. Operations of blocks 1205 to 1217 may thus be repeated for each TS packet of the transport stream so that payloads of TS packets including PES packet headers/data of independently coded video frame packets are selectively encrypted without encrypting TS headers and without encrypting TS payloads that do not include data of independently coded video frame packets.

Operations of FIG. 12 will now be discussed by way of example with respect to the portion of a transport stream illustrated in FIG. 15. At block 1201, the transport stream may be received at processor 401 through input interface 405 and stored in memory 407. At block 1203, processor 401 may select the 1^{st} TS packet. Because the payload of the 1^{st} TS packet includes a PES header 1501 and initial data 1503a of an independently coded video frame packet at blocks 1205 and 1209, processor 401 may set the flag in the TS header of the 1^{st} TS packet (e.g., in the TSC field) to a value “11” at block 1215 and selectively encrypt the payload of the 1^{st} TS packet (including the PES header 1501 and PES data 1503a) at block 1221 without encrypting the TS packet header of the 1^{st} TS packet.

At blocks 1219 and 1221, processor 401 may select the 2^{nd} TS packet. Because the payload of the 2^{nd} TS packet includes more data 1503b of the independently coded video frame packet at blocks 1205 and 1209, processor 401 may set the flag in the TS header of the 2^{nd} TS packet (e.g., in the TSC field) to a value “10” at block 1211 and selectively encrypt the payload of the 2^{nd} TS packet (including PES data 1503b) at block 1221 without encrypting the TS packet header of the 2^{nd} TS packet.

At blocks 1219 and 1221, processor 401 may select the 3^{rd} TS packet. Because the payload of the 3^{rd} TS packet includes more data 1503c of the independently coded video frame packet at blocks 1205 and 1209, processor 401 may set the flag in the TS header of the 3^{rd} TS packet (e.g., in the TSC field) to a value “10” at block 1211 and selectively encrypt the payload of the 3^{rd} TS packet (including PES data 1503b as well as the PES header 1511 and PES data 1513a of a dependently coded video frame) at block 1221 without encrypting the TS packet header of the 3^{rd} TS packet.

At blocks 1219 and 1221, processor 401 may select the 4^{th} TS packet. Because the payload of the 4^{th} TS packet does not include data of any independently coded video frame packet at block 1205, processor 401 may set the flag in the TS header of the 4^{th} TS packet (e.g., in the TSC field) to a value “00” at block 1207 without encrypting the payload of the 4^{th} TS packet.

At blocks 1219 and 1221, processor 401 may select the 5^{th} TS packet. Because the payload of the 5^{th} TS packet does not include data of any independently coded video frame packet at block 1205, processor 401 may set the flag in the TS header of the 5^{th} TS packet (e.g., in the TSC field) to a value “00” at block 1207 without encrypting the payload of the 5^{th} TS packet.

Once processor 401 has processed all packets of the transport stream through operations of FIG. 12, the encrypted transport stream may be stored in memory 407 with TS payloads that include data of independently coded video frames being encrypted, with other TS payloads being unencrypted, with all TS headers being unencrypted, and with flags in the TS headers indicating whether the respective payloads are encrypted or unencrypted. The encrypted transport stream may thus be made available to entertainment system 100.

According to some embodiments, the encrypted TS stream and the original unencrypted TS stream may be stored separately in memory 407. Accordingly, processor 401 may perform quality assurance by decrypting the encrypted TS stream and comparing the result with the original unencrypted TS stream. According to some other embodiments, the encrypted TS stream may be saved as a modification of the original unencrypted TS stream so that the original unencrypted TS stream does not remain in memory 407.

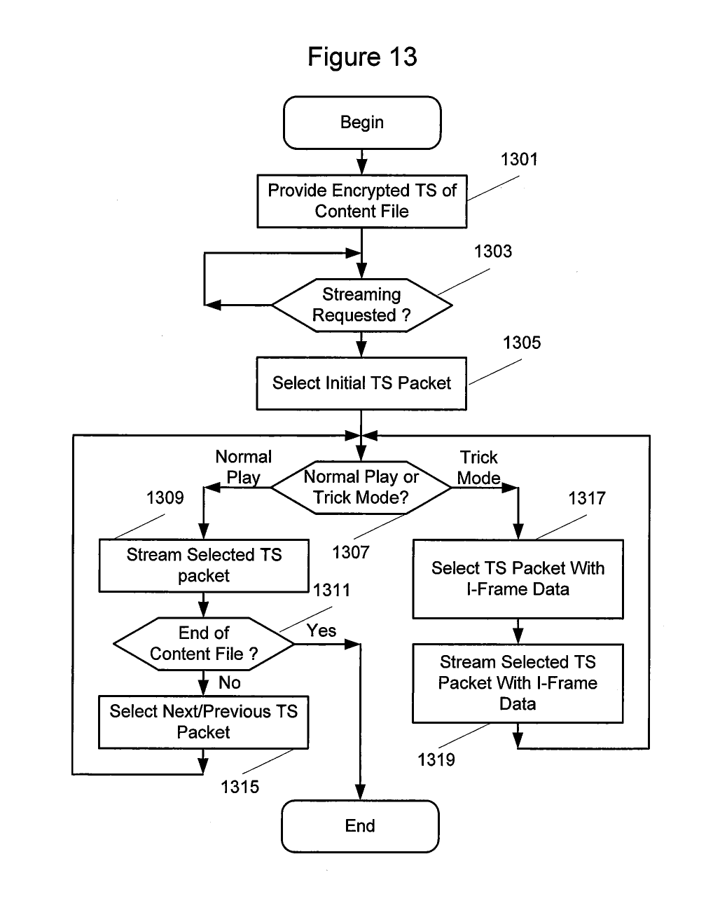

Operations of head end content server 101 of FIG. 2 according to some embodiments will be discussed in greater detail below with respect to FIG. 13. The encrypted transport stream discussed above with respect to FIG. 12 may be received by processor 201 through input interface 205 and stored in memory 207 at block 1301. Responsive to a streaming request from/for a display unit 105 at block 1303, processor 201 may select a TS packet at block 1305.

Responsive to a request for normal play operation streaming at block 1307 (e.g., a play command), processor 201 may stream selected TS packets to the display unit 105 in sequential order of the transport stream at blocks 1309, 1311, 1315, and 1307 without consideration of indications relating to selective encryption (e.g., flags in TSC fields of TS headers). More particularly, a selected TS packet may be streamed to the display unit 105 at block 1309, and as long the end of the content file has not been reached (e.g., there is at least another TS packet) at block 1311 and normal play operations are maintained at block 1307, a next TS packet in the transport stream may be streamed at block 1309. During normal play operation, TS packets having the first flag value and transport stream packets having the second/third flag value may be streamed so that independently coded and dependently coded video frame packets are streamed.

With respect to the TS packets illustrated in FIG. 15 during normal play operation, processor 201 may select the 1^{st} TS packet at block 1305, and responsive to normal play operation, processor 201 may stream the 1^{st} TS packet to the display unit 105. Because more TS packets follow the 1^{st} TS packet (e.g., the end of the TS stream has not been reached) at block 1311, processor 201 may select the 2^{nd} TS packet at block 1315 and stream the 2^{nd} TS packet to the display unit 105. During continued normal play operation, processor 201 may continue streaming the 3^{th}, 4^{th}, and 5^{th} and any subsequent TS packets until either the end of the transport stream is reached at block 1311, a command for trick mode operation is receive at block 1307, or another command (e.g., stop/pause) is received.

If a trick mode command (e.g., request fast forward, fast reverse, random access, etc.) is received by processor 201 (through network interface 203) at block 1307, processor 201 may selectively stream TS packets having the second/third flag value(s) without streaming TS packets having the first flag value at blocks 1307, 1317, and 1319. Once a trick mode command is received by processor 201 at block 1307, processor 201 may skip to a next/previous TS packet including independently coded video frame data using the encryption flags discussed above (e.g., provided in TSC fields of the TS packet headers). By using flags in the unencrypted TS packet headers to select TS packets for streaming during trick mode operations, processor 201 does not need to decrypt TS packet payloads to identify independently coded video frame packets using PES headers. Processing overhead at processor 201 may thus be reduced.

By way of example with respect to the TS packets of FIG. 15 during a trick mode fast forward operation, processor 201 may select the 1^{st} TS packet at block 1317 based on the encryption flag (e.g., “11”) provided in the respective TS packet header at block 1317 and stream the 1^{st} TS packet through network interface 203 to the display unit 105 at block 1319. Provided that the trick mode fast forward operation is maintained at block 1307, processor 201 may select the 2^{nd} TS packet at block 1317 based on the encryption flag (e.g., “10”) provided in the respective TS packet header at block 1317 and stream the 2^{nd} TS packet through network interface 203 to the display unit 105 at block 1319. Provided that the trick mode fast forward operation is maintained at block 1307, processor 201 may select the 3^{rd} TS packet at block 1317 based on the encryption flag (e.g., “10”) provided in the respective TS packet header at block 1317 and stream the 3^{rd} TS packet through network interface 203 to the display unit 105 at block 1319. Processor 201 may thus stream all TS packets including the PES header 1501 and data 1503a, 1503b, and 1503c of the PES packet including the independently coded video frame.

Once the 1^{st}, 2^{nd}, and 3^{rd} TS packets including the independently coded video frame PES packet have been streamed as discussed above, processor 201 may skip the 4^{th} and 5^{th} TS packets (and any other subsequent TS packets) that do not include data of an independently coded video frame packet based on the non-encryption flag (e.g., “00”) provided in the respective TS packets headers to select a subsequent TS packet with data of a subsequent independently coded video frame at block 1317. Processor 201 can thus quickly identify TS packets with/without data of an independently coded video frame packet based on the encryption/non-encryption flags. By providing different encryption flags (e.g., “11” and “10”) for initial TS packets (e.g., the 1^{st} TS packet of FIG. 15) and subsequent TS packets (e.g., the 2^{nd} and 3^{rd} TS packets of FIG. 15) of an independently coded video frame packet, processor 201 may quickly/efficiently identify the initial TS packet of each independently coded video frame packet.

Processor 201 may thus use encryption/non-encryption flags to support different trick mode operations. For example, for 2-times (×2) fast forward/reverse operation, processor 201 may use the encryption flags to skip to TS packets of every second next/previous independently coded video frame packet; for 4-times (4×) fast forward/reverse operation, processor 201 may use the encryption flags to skip to TS packets of every fourth next/previous independently coded video frame packet; for 8-times (8×) fast forward/reverse operation, processor 201 may use the encryption flags to skip to TS packets of every eighth next/previous independently coded video frame packet; for 16-times (16×) fast forward/reverse operation, processor 201 may use the encryption flags to skip to TS packets of every sixteenth next/previous independently coded video frame packet; for 32-times (32×) fast forward/reverse operation, processor 201 may use the encryption flags to skip to TS packets of every thirty second next/previous independently coded video frame packet; and for 64-times (64×) fast forward/reverse operation, processor 201 may use the encryption flags to skip to TS packets of every sixth fourth next/previous independently coded video frame packet. With different encryption flags (e.g., “11” and “10”) for initial and subsequent TS packets including data of an independently coded video frame packet, processor 201 can use the encryption flag for the initial TS packets to quickly find a start point for each next/previous independently coded video frame packet.

As discussed above, the transport stream may include additional packetized elementary streams (e.g., an audio PES, a closed caption PES, a subtitles PES, etc.) multiplexed with the packetized elementary stream of video frame packets onto the transport stream.

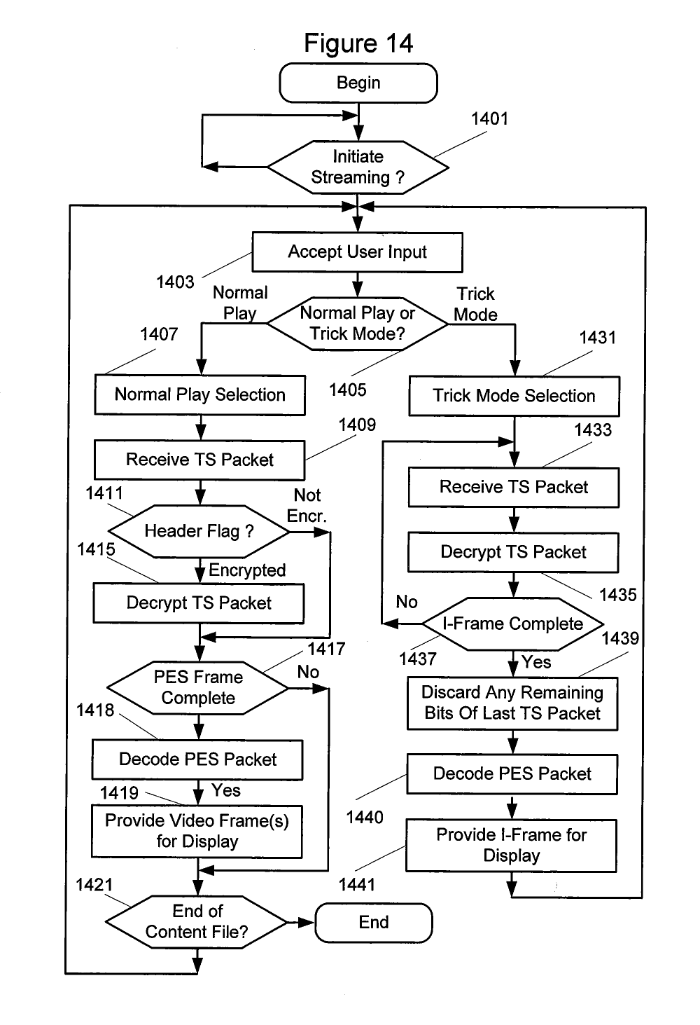

Operations of seat video display unit 105 of FIG. 3 according to some embodiments will be discussed in greater detail below with respect to FIG. 14. At block 1401, processor 301 may initiate streaming responsive to user input (e.g., identifying a content file and/or transport stream to be consumed), and at block 1403, processor 301 may accept user input through user interface 305 identifying a normal play or trick mode operation. Responsive to normal play operation at block 1405, processor 301 may proceed in accordance with operations 1407 to 1421, and responsive to trick mode operation at block 1405, processor 301 may proceed with operations 1431 to 1441. As indicated by the loops from blocks 1421 and 1441 back to block 1403, processor 301 may switch between normal play and trick mode operations.

During normal play operations, processor 301 may transmit a normal play selection command through network interface 203 to server 101 at block 1407. According to some embodiments, the normal play selection command may be transmitted once to initiate normal play operation without transmitting the normal play selection command each pass through operations 1407 to 1421, or the normal play selection command may be transmitted each pass through operations 1407 to 1421.

At block 1409, processor 301 may receive a TS packet from server 101 through network interface 303, and at block 1411, processor 301 may determine whether a payload of the TS packet is encrypted or not based on the encryption flag (e.g., “11” and/or “10”) or non-encryption flag (e.g., “00”) that may be included, for example, in the TSC field as discussed above. If the header flag indicates that the payload is encrypted at block 1411, processor 301 may selectively decrypt the payload of the TS packet without decrypting the TS header at block 1415. If the header flag indicates that the payload is not encrypted at block 1411, processor 301 may proceed without decrypting the TS packet or its payload.

As discussed above, data of a PES packet may be included in payloads of a plurality of TS packets. For example, a PES packet may include PES header and data 1503a, 1503b, and 1503c of a single independently coded video frame that are included in the 1^{st}, 2^{nd}, and 3^{rd} TS packets. Accordingly, processor 301 may determine at block 1417 if a complete PES packet has been received. If a complete PES packet(s) has been received at block 1417, processor 301 may decode the PES packet at block 1418 and provide the resulting video frame for display on display 309 of the display unit 105 at block 1419. If a partial PES packet has been received, at block 1418, processor 301 may wait until the PES packet is complete before attempting to decode and provide the corresponding video frame for display.

During normal play operation, processor 301 may thus receive a plurality of transport stream packets of the transport stream at block 1409, and selectively decrypt payloads of transport stream packets including data of independently coded video frame packets at blocks 1411 and 1415 without decrypting payloads of transport stream packets not including data of independently coded video frame packets at block 1411. The independently and dependently coded video frame packets from the payloads of the transport stream packets may be decoded at block 1418 using the selectively decrypted payloads of the transport stream packet(s) including data of the independently coded video frame packets. Moreover, the decoded video frame packets of the independently and dependently coded video frame packets may be provided for display on a display of display unit at block 1419.

During trick mode operations (e.g., fast forward/reverse, random access, etc.), processor 301 may transmit a trick mode selection command through network interface 203 to server 101 at block 1431. According to some embodiments, the trick mode selection command may be transmitted once to initiate trick mode operation without transmitting the trick mode selection command each pass through operations 1431 to 1441, or the trick mode selection command may be transmitted each pass through operations 1431 to 1441.

At block 1433, processor 301 may receive a TS packet from server 101 through network interface 303, and at block 1435, processor 301 may decrypt the payload of the TS packet without decrypting the TS header at block 1435. If the complete independently coded video frame packet has not been received/decrypted, processor 301 may repeat operations of blocks 1433, 1435, and 1437 until a complete independently coded video frame packet has been received. For example, three passes through operations 1433, 1435, and 1437 may be needed to receive all data 1503a, 1503b, and 1503c of the independently coded video frame packet included in the 1^{st}, 2^{nd}, and 3^{rd} TS packets of FIG. 15.

Once the complete independently coded video frame packet has been received and decrypted at block 1437, processor 301 may discard any remaining bits of a last of the TS packets that are not part of the independently coded video frame packet at block 1439. In the example using the 1^{st}, 2^{nd}, and 3^{rd} TS packets of FIG. 15, processor 301 may discard the PES header 1511 and the PES data 1513a of the 3^{rd} TS packet that are not a part of the independently coded video frame packet. At block 1440, processor 301 may decode the resulting PES independently coded video frame packet, and at block 1441, processor 301 may provide the independently coded video frame packet for display on display 309.

As shown in FIG. 14, operations of blocks 1431 to 1441 may be repeated as long at the trick mode operation is maintained.

During trick mode operation, processor 301 may receive a plurality of transport stream packets of the content file at blocks 1433 and 1437 wherein each of the plurality of transport stream packets includes a respective portion of an independently coded video frame packet of the packetized elementary stream of video frame packets. Processor 301 may decrypt payloads of the plurality of transport stream packets including the respective portions of the independently coded video frame packet at blocks 1435 and 1437. Once the complete independently coded video frame packet has been received by processor at block 1437, processor 301 may discard any remaining data that is not a part of the independently coded video frame packet at block 1439, decode the independently coded video frame packet using the decrypted payloads of the plurality of transport stream packets at block 1440, and provide the decoded independently coded video frame packet for display on the display unit.

As disclosed herein, embodiments of present inventive concepts may result in computational efficiencies and/or improvements that were previously unavailable using conventional technologies. For example, by encrypting without changing the number of content bytes before and after encryption, it may be easier for encryption system 411 to assure the quality (i.e., to provide quality assurance or QA) of the encrypted transport stream by decrypting the encrypted transport stream and performing a bit to bit comparison with the original unencrypted transport stream, and/or it may be easier for the head end content server 101 to use the same parameters provided by the video encoder during encoding.

Operations of head end content server 101 may be facilitated during trick mode operations because server processor 201 can use one bit of the TS header (i.e., the second bit of the TSC bit pattern) to efficiently identify each TS packet including the start of each I-Frame and another bit of the TS header (i.e., the first bit of the TSC bit pattern) to identify an end of each I-Frame. During trick mode operations, server processor 201 can thus efficiently identify exactly which TS packets to send without having to compute other parameters such as data rate and/or format (e.g., 480i, 480p, 720p, 1080p, 4K, etc.) provided by the video encoder during encoding session.

Computational efficiency of encryption system processor 411 may be improved because only TS packets including I-Frames (or portions thereof) may be encrypted without encrypting TS packets that do not include I-Frames or portions thereof. Because I-Frames are needed to decode P-Frames and B-Frames, all video frames can be protected without encrypting all video frames. Computational efficiency at display unit 105 may be similarly improved because decryption need only be performed for TS packets including I-Frame data. Accordingly, processing power (i.e., CPU power) may be reduced at display unit 105.

As disclosed herein, embodiments of present inventive concepts may result in making CBC mode of operation more resilient to transmission errors. According to embodiments disclosed herein wherein TS packets including I-Frame data are selectively encrypted, the CBC mode is restarted at each I-Frame, and therefore, a maximum loss due to a transmission error may be only one I-Frame. Streaming in normal mode, the picture at the SVDU may only be affected by a GOP (0.5 seconds of scrambled images) due to loss of a single I-Frame, while streaming in trick mode, the loss of a single I-Frame may only affect the picture at the SVDU by one quarter of 0.5 seconds (i.e., 0.125 seconds). In contrast, when using conventional CBC mode, each block of plaintext may be XORed with the previous ciphertext block before being encrypted so that each ciphertext block depends on all plaintext blocks processed up to that point. In the event of a transmission error using conventional CBC mode, the remaining part of the protected content may be lost if the whole video was encrypted.

In particular embodiment, encryption system 411 may be used to provide efficient MPEG encryption without changing video encoding performed by content provider and/or decoding performed by display unit 105. Encryption system 411 may provide encryption using video parameters provided by the video encoder as is. Moreover, content storage (e.g., at server memory 207 or at client local memory 307) and/or channel capacity of the network may be unaffected by encryption because both files (non-encrypted and encrypted) may have the same size. In addition, selective encryption according to some embodiments disclosed herein may be useful for any form of transport between two locations because the file size of the encrypted transport stream is the same as the file size of the original unencrypted transport stream.

Video streaming speeds provided by server 101 may be increased and/or server processor 201 load may be reduced for trick mode operations so that an increased number of clients (e.g., display units 105) can be served during combined normal and trick mode operations. For example, particular TS packets to send to make sure that whole I-frames are sent may be more efficiently identified using two flags (start and end of I-frame) instead of using calculations from bit rate and format (e.g., 480i, 480p, 720p, 1080p, 4K, etc.).

Because encryption may be provided at the MPEG2-TS level, an MPEG player (e.g., display unit 105) can decrypt the encrypted transport stream before the MPEG2-TS is opened for decoding of video, audio, closed caption, subtitles, etc. The MPEG decoder may need monitor only 2 flags (e.g., I-frame start and I-frame encrypted flags “11” and “10” of the TSC bits) to decrypt all PESs with these flags. No more or no less data may be used in the encrypted transport stream relative to the unencrypted transport stream according to embodiments disclosed herein (in contrast with differences in data that may occur with calculations based on data rates and video formats). MPEG players using streamed content or locally stored content may both benefit from efficiencies of encryption according to embodiments disclosed herein.

Computational efficiency of display unit processor 301 may be improved because processor 301 may be able to identify the end of each I-Frame and discard remaining date only from the last TS packet of an I-Frame. According to some prior encryption/decryption systems, decryption required parsing all TS packets to look for the end of an I-Frame and the beginning of another PES type (e.g., B-frame, P-frame, audio PES, CC PES, SUB PES, etc).

According to some embodiments disclosed herein, computational efficiencies may thus be improved at each of encryption system 411, display unit 105, and/or content server 101, thereby providing more efficient production of encrypted content at encryption server 411, transportation of encrypted content to head end server 101, loading and storage of encrypted content at head end server 101, streaming for normal and trick mode operations, propagation of encrypted content through IP networks, local storage of content on MPEG players, and/or decryption of streaming content or local content in normal or trick mode operations at display unit 105.

Further Definitions:

For the purposes of promoting an understanding of the principles of inventive concepts, reference has been made to the embodiments illustrated in the drawings, and specific language has been used to describe these embodiments. However, no limitation of the scope of inventive concepts is intended by this specific language, and inventive concepts should be construed to encompass all embodiments that would normally occur to one of ordinary skill in the art. The terminology used herein is for the purpose of describing the particular embodiments and is not intended to be limiting of example embodiments of inventive concepts.

Numerous modifications and adaptations will be readily apparent to those of ordinary skill in this art without departing from the spirit and scope of inventive concepts as defined by the following claims. Therefore, the scope of inventive concepts is defined not by the detailed description but by the following claims, and all differences within the scope will be construed as being included in inventive concepts.

For the sake of brevity, conventional electronics, systems, and software functional aspects of the systems (and components of the individual operating components of the systems) may not be described in detail. Furthermore, the connecting lines, or connectors shown in the various figures presented are intended to represent example communication/functional relationships and/or physical or logical couplings between the various elements. It should be noted that many alternative or additional functional relationships, physical connections or logical connections may be present in a practical device.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

The use of any and all examples, or exemplary language (e.g., “such as”) provided herein, is intended merely to better illuminate inventive concepts and does not pose a limitation on the scope of inventive concepts unless otherwise claimed. The use of the terms “a” and “an” and “the” and similar references in the context of describing inventive concepts (especially in the context of the following claims) are to be construed to cover both the singular and the plural, unless the context unambiguously indicates otherwise. In addition, it should be understood that although the terms “first,” “second,” etc. may be used herein to describe various elements, these elements should not be limited by these terms, which are only used to distinguish one element from another. The term “and/or”, abbreviated “/”, includes any and all combinations of one or more of the associated listed items.

When a node or other element is referred to as being “connected”, “coupled”, “responsive”, or variants thereof to another node, it can be directly connected, coupled, or responsive to the other node or intervening nodes may be present. In contrast, when a node is referred to as being “directly connected”, “directly coupled”, “directly responsive”, or variants thereof to another node, there are no intervening nodes present. Like numbers refer to like nodes throughout.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit (also referred to as a processor) of a general purpose computer circuit, a special purpose computer circuit, and/or another programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create functionality and/or structure to implement functions/acts specified in the block diagrams and/or flowchart block(s).

These computer program instructions may also be stored in a tangible computer-readable media that can direct a computer or other programmable data processing apparatus to function in a particular manner, such that the instructions stored in the computer-readable media produce an article of manufacture including instructions which implement the functions/acts specified in the block diagrams and/or flowchart block or blocks.

A tangible, non-transitory computer-readable media may include an electronic, magnetic, optical, electromagnetic, or semiconductor data storage system, apparatus, or device. More specific examples of the computer-readable media would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing device to cause a series of operational steps to be performed on the computer and/or other programmable apparatus to produce a computer-implemented process such that the instructions which execute on the computer or other programmable apparatus provide operations to implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Other servers, SVDUs, systems, and/or methods according to embodiments of inventive concepts will be or become apparent to one with skill in the art upon review of the present drawings and description. It is intended that all such additional servers, SVDUs, systems, and/or methods be included within this description, be within the scope of present inventive concepts, and be protected by the accompanying claims. Moreover, it is intended that all embodiments disclosed herein can be implemented separately or combined in any way and/or combination.

That which is claimed is:

1. A method of providing video at a display unit using an encrypted transport stream of a content file, the method comprising:
during normal play operation, receiving a plurality of transport stream packets of the encrypted transport stream, wherein a packetized elementary stream of video frame packets including independently coded and dependently coded video frame packets is multiplexed onto the encrypted transport stream;
during normal play operation, selectively decrypting payloads of transport stream packets including data of independently coded video frame packets without decrypting payloads of transport stream packets not including data of independently coded video frame packets; and
during normal play operation, decoding the independently and dependently coded video frame packets from the payloads of the transport stream packets using the selectively decrypted payloads of the transport stream packets including data of the independently coded video frame packets; and
during normal play operation, providing the decoded video frame packets of the independently and dependently coded video frame packets for display on a display.

2. The method of claim 1, further comprising:
during trick mode operation, receiving a plurality of transport stream packets of the content file wherein each of the plurality of transport stream packets includes a respective portion of an independently coded video frame packet of the packetized elementary stream of video frame packets;
during trick mode operation, decrypting payloads of the plurality of transport stream packets including the respective portions of the independently coded video frame packet;
during trick mode operation, decoding the independently coded video frame packet using the decrypted payloads of the plurality of transport stream packets; and
during trick mode operation, providing the decoded independently coded video frame packet for display on the display unit.

3. The method of claim 2 wherein the plurality of transport stream packets comprises a plurality of sequential transport stream packets including respective portions of the independently coded video frame packet, and wherein a last of the sequential transport stream packets includes a respective portion of the independently coded video frame packet and a portion of a dependently coded video frame packet, the method further comprising:
during trick mode operation, discarding data of the dependently coded video frame packet from the last of the sequential transport stream packets.

4. The method of claim 3 wherein the each of the transport stream packets that does not include data of an independently coded video frame packet includes a first flag value set in a header thereof, wherein a header of an initial one of the sequential transport stream packets including data of the independently coded video frame packet includes a second flag value set in a header thereof, and wherein the first and second flag values are different.

5. The method of claim 3 wherein headers of each non-initial one of the sequential transport stream packets including data of the independently coded video frame packet includes the second flag value set in a header thereof.

6. The method of claim 3 wherein headers of each non-initial one of the sequential transport stream packets including data of the independently coded video frame packet includes a third flag value set in a header thereof, wherein the first, second, and third flag values are different.

7. The method of claim 1 wherein each of the transport stream packets that does not include data of an independently coded video frame packet includes a first flag value set in a header thereof, wherein each of the transport stream packets that includes data of an independently coded video frame packet includes a second flag value and/or a third flag value set in a header thereof, and wherein selectively decrypting comprises selectively decrypting responsive to detecting the second and/or third flag value set in the headers of the transport stream packets including data of independently coded video frame packets.

8. The method of claim 1 wherein the each of the transport stream packets that does not include data of an independently coded video frame packet includes a first flag value set in a header thereof, wherein each of the transport stream packets that includes data of an independently coded video frame packet includes a second flag value set in a header thereof, and wherein selectively decrypting comprises selectively decrypting responsive to detecting the second flag value set in the headers of the transport stream packets including data of independently coded video frame packets.

9. The method of claim 1 wherein a packetized elementary stream of audio packets is multiplexed with the packetized elementary stream of video frame packets onto the transport stream.

10. The method of claim 1 wherein providing the decoded video frame packets of the independently and dependently coded video frame packets for display on a display of display unit comprises rendering video images of the decoded video frame packets on the display.

11. A method of streaming an encrypted transport stream of a content file, the method comprising:
providing the encrypted transport stream in memory, wherein the encrypted transport stream includes a plurality of transport stream packets, wherein a packetized elementary stream of video frame packets including independently coded and dependently coded video frame packets is multiplexed onto the transport stream, wherein a first flag value is set in headers of transport stream packets without data of independently coded video frame packets, and wherein a second flag value is set in headers of transport stream packets including data of independently coded video frame packets;
during normal play operation, streaming transport stream packets having the first flag value and transport stream packets having the second flag value so that independently coded and dependently coded video frame packets are streamed; and
during trick mode operation, selectively streaming transport stream packets having the second flag value without streaming transport stream packets having the first flag value.

12. The method of claim 11 wherein a packetized elementary stream of audio packets is multiplexed with the packetized elementary stream of video frame packets onto the transport stream.

13. The method of claim 11 wherein streaming transport stream packets during normal play operation comprises streaming transport stream packets responsive to receiving a play command, and wherein selectively streaming transport stream packets having the second flag value during trick mode operation comprises selectively streaming responsive to receiving a fast forward and/or a fast reverse command.

14. The method of claim 13 wherein streaming transport stream packets during normal play operation comprises streaming transport stream packets to a display unit, and wherein streaming transport stream packets during trick mode operation comprises selectively streaming transport stream packets to the display unit.

15. A method of encrypting a transport stream of a content file including a plurality of transport stream packets, wherein a packetized elementary stream of video frame packets including independently coded and dependently coded video frame packets is multiplexed onto the transport stream, the method comprising:
setting a first flag value in a header of a first transport stream packet of the transport stream indicating that the first transport stream packet does not include data of an independently coded video frame packet;
setting a second flag value in a header of a second transport stream packet of the transport stream indicating that the second transport stream packet includes data of an independently coded video frame packet, wherein the first and second flag values are different; and
selectively encrypting a payload of the second transport stream packet without encrypting the header of the first and second transport stream packets and without encrypting the payload of the first transport stream packet.

16. The method of claim 15 wherein setting the header field of the first transport stream packet comprises setting the header field of the first transport stream packet to the first flag value without encrypting the payload of the first transport stream packet.

17. The method of claim 15 wherein the first transport stream packet includes data of a dependently coded video frame packet, wherein a dependently coded video frame packet is dependent on information of at least one other video frame packet of the packetized elementary stream of video frame packets for decoding.

18. The method of claim 15 wherein the independently coded video frame packet is coded independently of any other video frame packets of the packetized elementary stream.

19. The method of claim 15 wherein the independently coded video frame packets of the packetized elementary stream comprise intra-coded video frame packets, and wherein the dependently coded video frame packets of the packetized elementary stream comprise inter-coded video frame packets.

20. The method of claim 19 wherein the inter-coded video frame packets of the packetized elementary stream include predicted video frame packets that are that are dependent on one other video frame packet of the packetized elementary stream of video frame packets for decoding and bi-predicted video frame packets that are dependent on two other video frame packets of the packetized elementary stream of video frame packets for decoding.

21. The method of claim 20 wherein the transport stream of the content file comprises a transport stream according to an MPEG standard, wherein the intra-coded video frame packets comprise I-frame video packets according to the MPEG standard, wherein the predicted video frame packets comprises P-frame video packets according to the MPEG standard, and wherein the bi-predicted video frame packets comprises B-frame video packets according to the MPEG standard.

22. The method of claim 15 wherein the payload of the second transport stream packet includes a packetized elementary stream header of the independently coded video frame packet and initial data of the independently coded video frame packet, the method further comprising:
setting a third flag value in a header of a third transport stream packet indicating that the third transport stream packet includes subsequent data of the independently coded video frame packet, wherein the third flag value is different than the first and second flag values; and
selectively encrypting a payload of the third transport stream packet without encrypting the header of the third transport stream packet.

23. The method of claim 22 wherein each of the first, second, and third flag values is set in a transport control scrambling field of the respective header.

24. The method of claim 22 wherein the initial data of the independently coded video frame packet and the subsequent data of the independent coded video frame packet comprise initial and subsequent data of the same independently coded video frame packet.

25. The method of claim 15 wherein a packetized elementary stream of audio packets is multiplexed with the packetized elementary stream of video frame packets onto the transport stream.

26. The method of claim 15 wherein a byte size of the second transport stream packet before encrypting is the same as a byte size of the second transport stream packet after encrypting.
